(19) United States
(12) Patent Application Publication
(10) Pub. No.: US 2025/0226791 A1
(43) Pub. Date: Jul. 10, 2025

(54) Solar Panel Mounting Systems and Methods

(71) Applicant: Sarcos Corp., Salt Lake City, UT (US)

(72) Inventors: Fraser M. Smith, Salt Lake City, UT (US); Matthew Torok, Cary, NC (US)

(21) Appl. No.: 19/013,839

(22) Filed: Jan. 8, 2025

Related U.S. Application Data
(60) Provisional application No. 63/618,789, filed on Jan. 8, 2024.

(51) Int. Cl. H02S 30/10

(52) U.S. Cl. CPC H02S 30/10

(57) ABSTRACT

A solar panel mounting system can include a first panel mount including a first retaining feature attached to or attachable to a first torque tube clamp, and a second panel mount including a second retaining feature attached to or attachable to a second torque tube clamp. When the first and second panel mounts are mounted on a torque tube via the first and second torque tube clamps, respectively, the first retaining channel faces the second retaining channel, and the first and second retaining channels are oriented transversely relative to the torque tube. Furthermore, in this example, at least one of the first panel mount or the second panel mount is configured for overhead or lateral insertion of a solar panel while the torque tube clamps are installed on the torque tube.

### RELATED APPLICATIONS

This application claims the benefit of U.S. Provisional Application Ser. No. 63/618,789, filed Jan. 8, 2024, and entitled, “Solar Panel Mounting Systems and Methods” which is incorporated by reference in its entirety herein.

This application is also related to U.S. application Ser. No. ______, filed Jan. 8, 2025, and entitled, “Torque Tube Clamps for Automated Solar Panel Installation” (Attorney Docket No. 4000-23.0015.US.NP); U.S. application Ser. No. ______, filed Jan. 8, 2025, and entitled, “Dispensing Hopper and Presentation System for Overhead Installation of Solar Panels for A Solar Tracking System” (Attorney Docket No. 4000-23.0016.US.NP); U.S. application Ser. No. ______, filed Jan. 8, 2025, and entitled, “Solar Panel Installation Alignment Systems” (Attorney Docket No. 4000-23.0017.US.NP); U.S. application Ser. No. ______, filed Jan. 8, 2025, and entitled, “Solar Panel Installation Vehicles as Part of a Solar Panel Installation System for A Solar Tracking System” (Attorney Docket No. 4000-23.0018.US.NP); and U.S. application Ser. No. ______, filed Jan. 8, 2025, and entitled, “Support Clamp Installation Vehicles as Part of a Solar Panel Installation System for A Solar Tracking System” (Attorney Docket No. 4000-23.0019.US.NP), each of which is incorporated by reference in its entirety herein.

### BACKGROUND

In recent years, electricity generation through the use of solar panels has become much more common and widespread then has been previously known. Solar panels and solar panel arrays are commonly installed on both commercial and residential buildings, as well as other structures. Additionally, large solar panel arrays are commonly installed on mounts in open fields and spaces.

With solar panel arrays and solar panel installation becoming more common in society, quicker and more efficient ways of installing solar panels are necessary in order to increase rates and decrease costs at which solar panel arrays can be installed. For this reason, systems, devices, and methods for installing solar panels continue to be developed. Furthermore, mounts and supports for receiving solar panels that can work well for both manual installation or with installation devices continue to be developed in order to facilitate quick and efficient installation and operation of solar panels with installation devices.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1A illustrates a perspective view of an example automated overhead solar panel assembly vehicle for installing solar panels along a torque tube in accordance with the present disclosure;

FIG. 1B illustrates a perspective view of an example pair of vehicles coordinated by precision GPS for automated overhead solar panel installation along a torque tube in accordance with the present disclosure;

FIG. 2A illustrates an example frameless solar panel including a solar panel element mounted on support rails in accordance with the present disclosure;

FIG. 2B illustrates an example solar panel including a solar panel element mounted in a support frame in accordance with the present disclosure;

FIGS. 3A-3C illustrate a partial perspective view of an example torque tube mounting clamp coupled with a torque tube, with the torque tube mounting clamp also attached to a panel mount at various stages of overhead insertion of a solar panel into the panel mount in accordance with the present disclosure;

FIGS. 4A-4D illustrate an example automation tool inserting a solar panel into a spring-loaded panel mount at various stages of overhead insertion of a solar panel into the panel mount in accordance with the present disclosure;

FIGS. 5A-5B illustrate an example pivotable spring-loaded panel mount at various stages of overhead insertion of a solar panel into the panel mount in accordance with the present disclosure;

FIGS. 6A-6B illustrate an alternative example pivotable spring-loaded panel mount at various stages of overhead insertion of a solar panel into the panel mount in accordance with the present disclosure;

FIGS. 7A-7C illustrate another alternative example pivotable panel mount at various stages of overhead insertion of a solar panel into the panel mount in accordance with the present disclosure;

FIGS. 8A-8C illustrate an example panel mount with spring-loaded pins at various stages of overhead insertion of a solar panel into the panel mount in accordance with the present disclosure;

FIGS. 9A-9B illustrate an example panel mount with an engagement pin (or a multi-level engagement pin) that is spring-loaded for lateral (sliding) insertion of a solar panel into the panel mount in accordance with the present disclosure;

FIGS. 10A-10D illustrate an alternative example panel mount with a plurality of multi-level engagement pins that are spring-loaded at various stages of lateral (sliding) insertion of a solar panel into the panel mount in accordance with the present disclosure;

FIGS. 11A-11C illustrate an example panel mount with a lever-assisted spring-loaded pin at various stages of lateral (sliding) insertion of a solar panel into the panel mount in accordance with the present disclosure;

FIGS. 12A-12B illustrate an example panel mount with a lever-assisted (and in some instances, spring-loaded) pin for lateral (sliding) insertion of a solar panel into the panel mount in accordance with the present disclosure;

FIGS. 13A-13B illustrate an example panel mount with an alternative lever-assisted spring-loaded pin at various stages of lateral (sliding) insertion of a solar panel into the panel mount in accordance with the present disclosure;

FIGS. 14A-14D illustrate an example panel mount with an alternative lever-assisted spring-loaded pin at various stages of overhead insertion of a solar panel into the panel mount in accordance with the present disclosure;

FIGS. 15A-15C illustrate an example panel mount with spring-loaded pins at various stages of overhead insertion of a solar panel into the panel mount in accordance with the present disclosure;

FIG. 16 illustrates an example solar panel mounting system including multiple panel mounts with lead-in latches positioned along a torque tube in accordance with the present disclosure;

FIGS. 17A-17D illustrate various views of a panel mount with a lead-in latch assembly suitable for lateral (sliding) insertion of a solar panel into the panel mount in accordance with the present disclosure;

FIGS. 18A-18D illustrate an example of operation of a panel mount with a lead-in latch assembly in accordance with the present disclosure;

FIG. 19 illustrates an alternative example panel mount with a lead-in latch assembly in the form of an elastically deflectable cantilevered beam in accordance with the present disclosure;

FIG. 20 illustrates an example panel mount with a spring-loaded pin in accordance with the present disclosure;

FIGS. 21A-21C illustrate an example flexible panel mount at various stages of overhead insertion of a solar panel into the panel mount in accordance with the present disclosure;

FIGS. 22-25 illustrate various example flexible panel mounts suitable for overhead insertion of a solar panel into the panel mount in accordance with the present disclosure;

FIGS. 26A-26B illustrate example flexible panel mounts that are laterally offset to reduce space between adjacent solar panels, and which are suitable for overhead insertion of a solar panel into the panel mount in accordance with the present disclosure;

FIGS. 27A-27C illustrate an example flexible panel mount at various stages of overhead insertion of a solar panel into the panel mount in accordance with the present disclosure;

FIGS. 28A-28D illustrate an example panel mount with an over-center linkage locking mechanism at various stages of overhead insertion of a solar panel into the panel mount in accordance with the present disclosure;

FIGS. 29A-29D illustrate an example panel mount with an alternative over-center linkage locking mechanism at various stages of overhead insertion of a solar panel into the panel mount in accordance with the present disclosure; and

FIGS. 30A-30B illustrate example panel mount clamp assembly including multiple panel mounts attached to a clamp support of torque tube clamp (FIG. 30A) and multiple solar panels also attached to the panel mounts (FIG. 30B) after over overhead insertion into the panel mounts in accordance with the present disclosure

### DETAILED DESCRIPTION

In accordance with examples of the present disclosure, a solar panel mounting system can include a first panel mount including a first retaining feature attached to or attachable to a first torque tube clamp, and a second panel mount including a second retaining feature attached to or attachable to a second torque tube clamp. In this example, when the first and second panel mounts are mounted on a torque tube via the first and second torque tube clamps, respectively, the first retaining feature faces the second retaining feature, and the first and second retaining features are oriented transversely relative to the torque tube. Furthermore, in this example, at least one of the first panel mount or the second panel mount is configured for overhead or lateral insertion of a solar panel while the torque tube clamps are installed on the torque tube. In some examples, the first panel mount and the second panel mount can be cantilevered orthogonally relative to the torque tube.

In another example, a method of installing solar panels can include coupling a plurality of torque tube clamps at multiple locations along an elongated torque tube, and individually coupling a plurality of panel mounts to the plurality of torque tube clamps. The panel mounts can be oriented transversely with respect to the torque tube, and the panel mounts each can include a retaining feature configured to engage with a support frame or support rail of a solar panel. In further detail, the method can include installing a plurality of solar panels to engage with retaining features of multiple panel mounts positioned adjacent one another in a direction along the torque tube without the need of separate hardware or fasteners other than retaining features integrated as part of the panel mounts.

In another example, a panel mount clamp assembly can include a torque tube clamp attachable to a torque tube that can be configured such that when the torque tube clamp is secured to the torque tube, the torque tube clamp rotates with the torque tube without slipping. The panel mount clamp assembly can likewise include a panel mount attached to or integrated with the torque tube clamp, wherein the panel mount includes a first retaining feature adapted to receive and retain a first support frame or support rail of a first solar panel and a second retaining feature adapted to receive and retain a second support frame or support rail of a second solar panel installed adjacently relative to the first solar panel.

In another example, a method of installing a solar panel can include inserting a first solar panel and a second solar panel into a panel mount clamp assembly described herein to secure the first solar panel with the first retaining feature and to secure the second solar panel with the second retaining feature.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

It is noted that when discussing the solar panel mounting systems, the panel mount clamp assemblies, or the methods of installing solar panels described herein, these discussions are considered applicable to other examples whether or not they are explicitly discussed in the context of that example unless expressly indicated otherwise. Thus, for example, when discussing a certain panel mount in the context of the solar panel mounting systems, such disclosure is also relevant to and directly supported in context of the other examples, including the panel mount clamp assemblies and methods of installing solar panels, and vice versa.

For simplicity and illustrative purposes, numerous specific details are set forth in order to provide a thorough understanding of the present disclosure. It will be readily apparent however, that the present disclosure can be practiced without limitation to some of these specific details. In other instances, certain methods, systems, materials, and structures have not been described in detail so as not to obscure the present disclosure.

Furthermore, reference numerals are used uniformly herein, so for clarity, in certain instances, a reference numeral may be shown in a specific figure but may not be specifically discussed to avoid unnecessary redundancy.

### Automated Panel Installation of Framed and Frameless Solar Panels

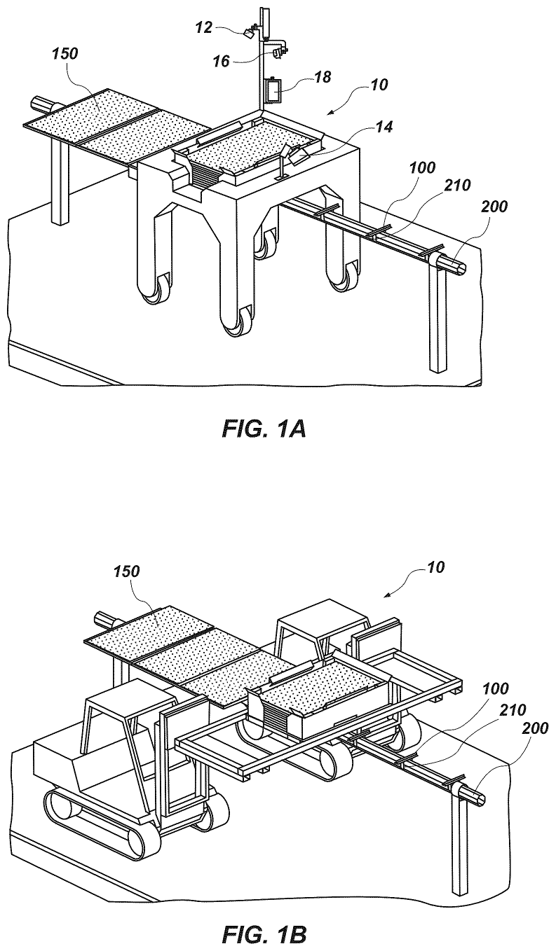

Referring now to FIGS. 1A and 1B, a few automated panel installation vehicles or vehicle systems are shown at 10. More specifically, FIG. 1A illustrates an automated panel installation vehicle that rides over the top and straddles a torque tube 200 for overhead solar panel 150 installation. FIG. 1B illustrates an automated panel installation vehicle system which includes multiple vehicles that can be coordinated and controlled using a GPS device for overhead solar panel installation. For example, RTKGPS may be used to move two machines together, in some instances within very small tolerances. In further detail, similar automated vehicles can be configured for lateral (slidable) solar panel insertion. For purposes of alignment of the solar panels during installation, there are several mechanical features described in greater detail hereinafter. However, it is noted that the automated panel installation vehicles or vehicle systems can be equipped with sensory equipment, such as laser alignment features 16, perception sensors (cameras) 12 and 16, etc. For example, as shown by way of example, a few different alignment features are shown, which may include perception sensors positioned on the automated vehicle in the example shown, as well as a laser alignment device. In some examples, there may also be a display or control interface 18 for inputting and/or receiving information regarding the automated panel installation vehicle(s) or systems, as well as various safety features, such as sound emitters, light emitters, etc. Furthermore, in both examples, the torque tube has been outfitted with a series of torque tube clamps 210 each having a panel mount 100 attached thereto. The panel mounts are spaced apart at a distance suitable for receiving and retaining a series of solar panels being installed sequentially. In other examples (not shown), a single machine may be used on one side for lateral solar panel insertion, e.g., sliding between adjacent panel mounts, mounting from overhead by angled insertion, etc.

There are a number of ways of detecting a given fiducial that may be present on a solar panel and/or on a panel mount to assist with proper automated alignment of the solar panels being installed in rows over a torque tube. Essentially, a “fiducial” or a “fiducial marker” refers to an object(s), marking(s) and/or integrated structure(s) associated with the solar panel and/or the panel mount. A fiducial may be likewise in the form of a marking(s) or structure(s) that is part of the imaging equipment, such as in the form of a reticle, etc. The fiducial is typically in the field of view of an imaging or sensing system, which is used for a point of reference for the equipment to sense and place or adjust solar panels during installation. Thus, these fiducials may be detectable on an already-installed solar panel or while installing a solar panel or a panel mount or a panel mount clamp assembly and/or may be present as part of imaging equipment, such as in the form of a reticle. For example, one or more cameras, LIDARS, IR-based sensors, ultrasonic sensors, structured light, or the light could be used to sense these fiducials. Other examples may include the use of a ferromagnetic element(s) in an otherwise non-ferromagnetic structure that would be detected by a magnet-based sensor, or a magnet may be used that is detectable by a Hall Effect sensor. In still other examples, RFID tags could be included in the panel mount or panel mount assemblies to provide proper alignment during installation and/or adjustment after installation. Other examples may include providing spots, lines, shapes, or other marking details (engraved, etched, printed, or otherwise present) that reflect a known light frequency or frequencies, thereby being easily readable by the sensing equipment, such as by being highly illuminated or bright when the appropriate wavelength of energy is used to illuminate the markings. In other examples, fiducials may likewise provide imaging details when a laser is shone at them, indicating alignment or a direction of misalignment to be corrected. For example, the fiducial may be in the form of multiple holes, with a second hole including a reflector at a known location, e.g., the center of the structure, which would indicate proper alignment by reflection. In some examples, if misaligned, the reflection could be engineered to generate a color or wavelength spectrum, or vice versa. Essentially, the automated panel installation vehicle(s) or systems may be designed to sense the correct location for alignment by these or any of a number of other approaches to provide for proper alignment of the solar panels during solar panel installation.

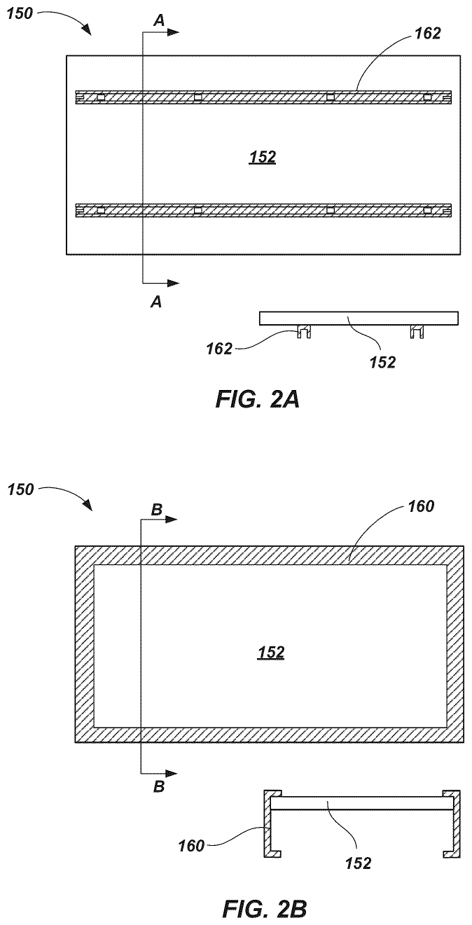

Alternatively, or in addition to the perception sensors, there the panel installation vehicle or vehicles may include mechanical guides for installation alignment. Mechanical guides may include various features on the mechanical guides that allow the panel installation vehicle to ensure proper placement and/or alignment. For example, mechanical guides may include one or more arms with stoppers or other structures to not allow the panel installation vehicle or vehicles to install the solar panels beyond a certain location and/or to not allow installation or disengagement from the solar panel at a location prior to being aligned properly. FIGS. 2A and 2B illustrate two different types of solar panels 150 that can be used in accordance with the present disclosure. FIG. 2A illustrates a frameless solar panel, which includes a solar panel element 152, e.g., PV, supported from underneath by a pair of support rails 162. A cross-sectional view of the frameless solar panel is shown at A-A for additional clarity. FIG. 2B illustrates a support framed solar panel, which includes the solar panel element, but rather than support rails, the solar panel element is supported by an exterior support frame 160 that essentially follows and retains the edges of the solar panel element. A cross-sectional view of the support framed solar panel is shown at B-B for additional clarity. It is noted that the panel mounts described herein are typically intended to interface with either the support frame of a solar panel or the support rails of the solar panel. In each of the examples herein, and particularly in the drawings, the illustrated example typically depicts the interface between the panel mount(s) and a panel support frame. However, it is noted that simple modification of size or other minor modification can be carried out to join the panel mount(s) with the support rails, and thus is considered to be part of the present disclosure.

In more specific detail regarding controlling the robotic systems and/or any of the assemblies, subassemblies, or subsystems thereof, any robotic systems, including computing systems, controllers, machine learning, or the like can be used with the automated panel installation of framed and/or frameless solar panels as described herein. For example, computing systems or controllers usable with the robotic systems or assemblies, subassemblies, or subsystems thereof can include any of a number of processors, I/O devices, network devices, and memory devices. The memory devices may include a data store and/or various modules. The computing systems or controllers may be connected with a display and/or control interface, for example, for human interface with the computing systems or controllers, for example. For example, various controller(s) may include and/or cooperate with any processor, server, system, device, computing device, other controller, microprocessor, microcontroller, microchip, semiconductor device, computer network, cloud computing, artificial intelligence (AI), machine learning, deep learning, or the like. The controller(s) may be configurable or configured to perform or enable autonomous, semi-autonomous, and/or user-controller managing, including controlling, monitoring, etc., of one or more elements, aspects, functionalities, operations, and/or processes of the robotic system. In some examples, the controller(s) may be configurable or configured to manage and/or control one or more elements, aspects, functionalities, operations, and/or processes of the mobile vehicle(s) (or any other structure that where an object managing system is mounted). For example, the controller(s) may be configurable or configured to manage, control movement, and or coordination of the mobile vehicle from one location to another location, including controlling one or more panel installation hoppers, robotic arms, robotic levers, wheels, stabilizing assemblies, variety of perception sensors, laser alignment features, sound emitters, light emitters, power sources, etc. In a specific example regarding perception sensing, the controller(s) can access and control optical cameras, IR cameras, LIDAR sensors, and any sensors to facilitate recognition and locating of one or more solar panels to be installed in one or more panel mounts, one or more torque tube clamps onto a torque tube, etc. For instance, the controller(s) can receive a two dimensional (2D) image from an optical camera for processing to roughly locate an object, e.g., a target object, using machine vision techniques, such as edge detection or blob analysis. The controller(s) can also (or alternatively) receive three dimensional (3D) data from a stereo image provided by a pair of optical cameras configured to facilitate stereo imaging or IR cameras. The data can be analyzed to map a precise location and orientation of the target object, as well as other, etc., at or around the target object. The controller(s) can operate as a perception sensors for the robotic system or any subassembly thereof to assist in installing a solar panel, a panel mount, a torque tube clamp, or a panel mount clamp assembly at any location along a torque tube. Such perception sensors in combination with the controller(s) can likewise access other sensors, such as a force sensor, a LIDAR sensor and/or a rangefinder sensor to provide additional 2D and 3D information about the surroundings and operation of the various components of the robotic systems.

It is noted herein that any of the controller(s) discussed and disclosed herein can comprise similar components that function similarly. It is also noted that any of the controller(s) discussed and disclosed herein can be configured to communicate and control any of the elements of the systems, subsystems, assemblies, subassemblies, devices, components, etc., of the robotic system, not just the particular components of the specific device or system in which the controller(s) reside. For example, a controller located within the mobile vehicle or installation hopper can control any components or all components of the object managing system or systems. Controller(s) may also be located remotely, connecting wirelessly with any component of the robotic system. However configured or wherever located, the controller(s) can include all of the hardware and/or software components to facilitate the communication and control of the robotic system or components thereof with respect to whatever example robotics are designed and implemented in accordance with the present disclosure.

### Solar Panel Mounting Systems and Panel Mount Clamp Assemblies

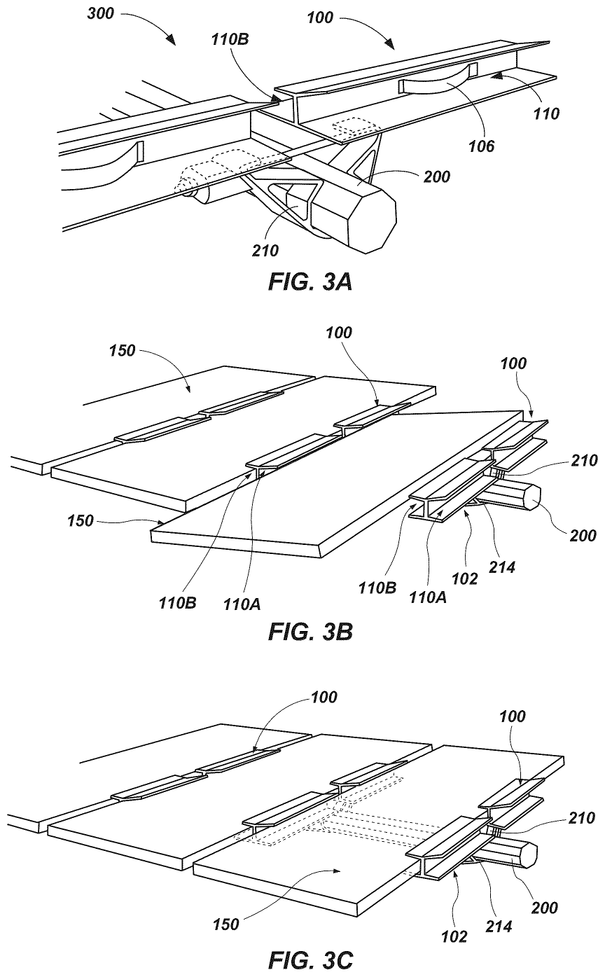

FIGS. 3A-3C illustrate an example solar panel mounting system in accordance with the present disclosure. As shown, panel mounts 100A and 100B can include retaining features, which in this instance, are retaining channels 110A and 110B. The panel mounts in this example are both attached to or are both attachable to torque tube clamps 210. Notably, a single panel mount can include multiple retaining features, one for retaining one solar panel 150 and another for retaining another solar panel. In further detail, as shown, a solar panel can be inserted into a first retaining channel 110A and then placed into a second retaining channel 110B of a different panel mount. Note that in this example, the first retaining channel is in the form of a C-channel, with the first retaining channel being defined to include three channel walls, e.g., a lower channel wall oriented orthogonally relative to a rear channel wall and an upper channel wall angled at greater than about 95° relative to the rear channel wall. The second retaining channel, on the other hand, is also a C-channel, but is shallower and its upper channel wall is essentially parallel with its lower channel wall (both being orthogonal relative to its rear channel wall.) In this configuration, the upper channel wall and deeper C-channel are configured to receive a solar panel 150 from overhead at an angle of insertion greater than about 5° relative to the orientation of the first channel wall. In this example, the solar panel is shown as a monolithic structure, but it is understood that the panel shown would typically be a solar panel element mounted on a support rail(s) or a support frame, as shown in FIGS. 2A and 2B, respectively. In this example, when the first and second panel mounts are mounted on a torque tube via the first and second torque tube clamps, respectively, the first retaining feature faces the second retaining feature, and the first and second retaining features are oriented orthogonally relative to the torque tube. Furthermore, in this example, at least one of the first panel mounts or the second panel mount is configured for overhead or lateral insertion of a solar panel while the torque tube clamps are installed on the torque tube. Also shown in this example, the first retaining channel is shown as including a biasing structure 106 to provide outward mechanical pressure against the solar panel, enhancing the fit of the solar panel between the first and second panel mounts. The biasing structure(s) described herein, for example, can be positioned at least partially within a panel support channel and can provide a tightening bias between two adjacent panel supports when a solar panel is installed therebetween. Example biasing structures include a spring, a resilient material, or other spring-like structure.

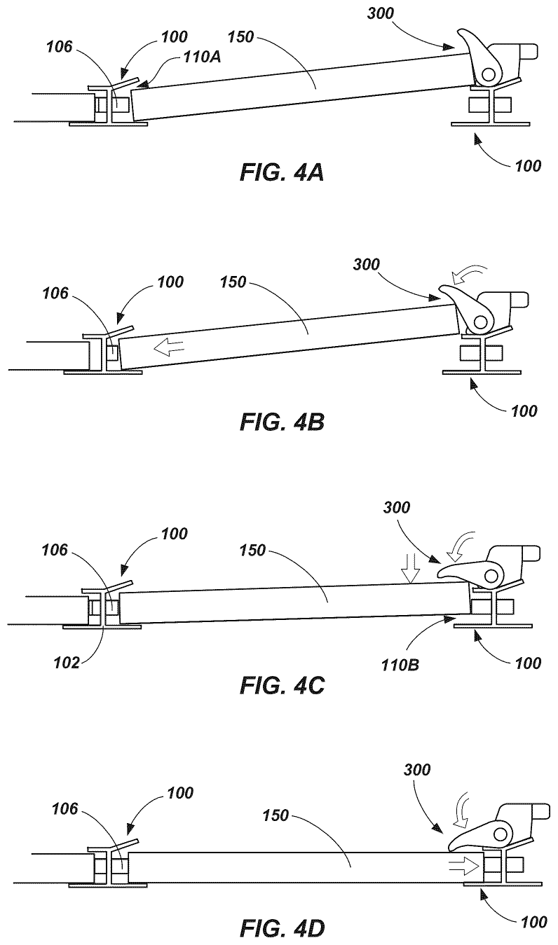

Referring now to FIGS. 4A-4D, an angled overhead insertion of a solar panel 150, similar to that shown in FIGS. 3A-3C, is shown as being installed with the aid of an automation tool 300. Again, in this example, the solar panel is shown as a monolithic structure for simplicity, but it is understood that the solar panel would typically include a solar panel element mounted on a support rail(s) or a support frame, as shown in FIGS. 2A and 2B, respectively. This automation tool shown is the structure that directly interfaces with the solar panel and could be connected to any number of automation assemblies, such as mechanical arms, vehicles, or the like. In this example, the automation tool includes a lever that is initially in an upward or open position so that upon inserting the solar panel into a retaining channel 110A opposite the automation tool, the solar panel can be accommodated next to the automation channel. Then, as the automation tool is rotated as shown in FIGS. 4B and 4C, the other edge of the solar panel may be dropped into retaining channel 110B. As shown, the biasing structures 106 can create some tension between the opposite edges of the solar panel. After the solar panel is fully seated between retaining channels 110A and 110B with the assistance of the biasing structures providing a firm installation, the automation tool may be removed and used to install the next solar panel along the torque tube (not shown).

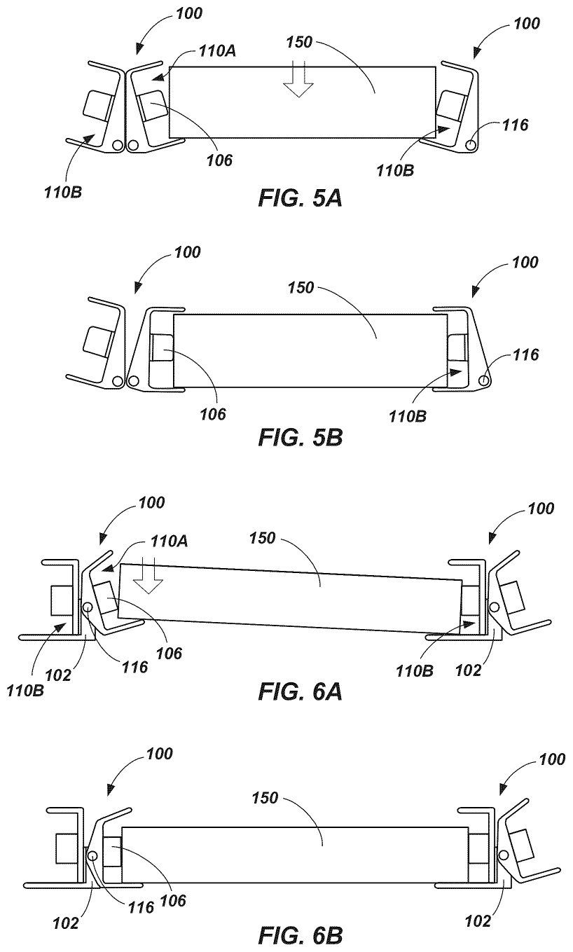

Referring now to FIGS. 5A and 5B, a solar panel mounting system is shown that includes a pair of panel mounts 100A and 100B positioned to receive a solar panel 150 by overhead installation. In this example, because the panel mounts are configured to rotate about a panel mount support pivot 116, the solar panel can be installed directly from above without the need to insert one edge of the solar panel prior to the other edge of the solar panel. Thus, the solar panel can be seated in the first retaining channel 110A and the second retaining channel 110B simultaneously by applying a downward force on the solar panel. Again, in this example, there are biasing structures 106 present to provide a firm fit between the retaining channels. Notably, the individual panel mounts may include both a first and second retaining channel, which are used independently for receiving two adjacent solar panels during installation.

FIGS. 6A and 6B illustrate an example solar panel mounting system similar to that shown at FIGS. 5A and 5B, except that in this instance, panel mount 100A includes a panel mount support pivot 116 and panel mount 100B does not include the pivot. Thus, in this instance, the solar panel can be installed overhead by inserting the solar panel into one of the retaining features (the second retaining feature 110B in this instance), followed by a downward force applied to the solar panel to seat the solar panel at the other edge into the first retaining channel 110A as a result of a pivoting feature associated with the retaining channel. Thus, in accordance with FIGS. 5A-6B, it is noted that the first panel mount, the second panel mount, or both can be pivotable or pivoted to an open orientation (see FIGS. 5A and 6A) to provide clearance for overhead solar panel insertion into the first support channel, the second support channel, or both (depending on which arrangement is used). Upon insertion, the first panel mount, the second panel mount, or both can then be pivoted to a closed orientation upon application of a downward force, such as to the solar panel. Again, in this example, there are biasing structures 106 present to provide a firm fit between the retaining channels. Notably, the individual panel mounts may include both a first and second retaining channel, which are used independently for receiving two adjacent solar panels during installation.

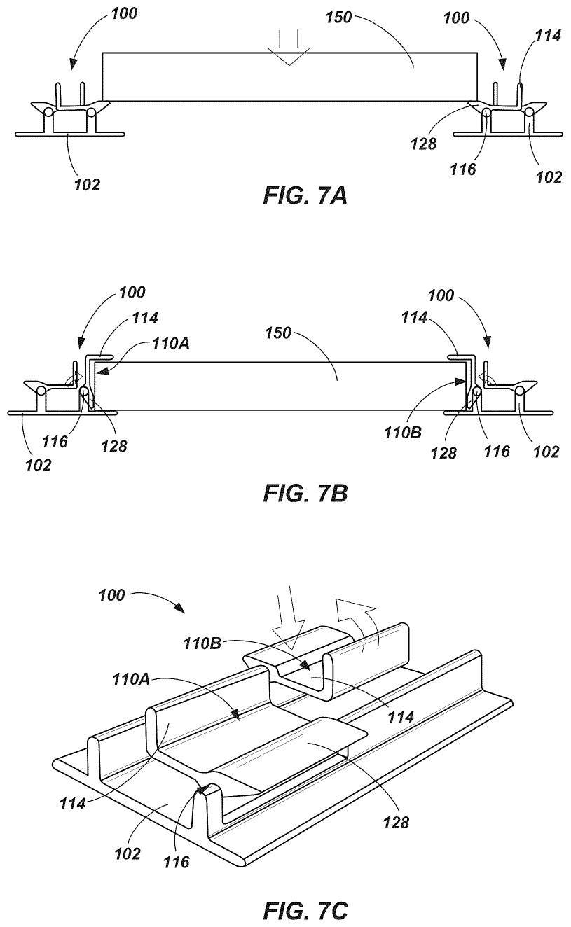

FIGS. 7A-7C illustrate another example solar panel mounting system similar in some ways to that shown at FIGS. 6A-6B, except that in this instance, rather than the use of biasing structures present on the panel mounts 100A and/or 100B, each panel mount includes a lever portion 128 as part of the channel wall that defines the respective retaining channels 110A and 110B. For example, the plan side view of FIG. 7A and the perspective view of FIG. 7C depict the panel mounts in an open orientation, and the plan side view of FIG. 7B depicts the panel mounts in a closed orientation after insertion of the solar pane 150. This is accomplished due to the panel mounts being rotatable about a panel mount support pivot 116.

Thus, in this instance, the solar panel can be installed overhead by inserting both sides of the solar panel 150 onto the lever portions of the panel mounts with a downward force, causing the position of the retaining channels to rotate and face opposing edges of the solar panel. In further detail, the lever portion is angled and has a thickness suitable for providing a relatively snug fit when the solar panel is fully seated between the respective retaining channels. In short, the panel mounts shown in FIGS. 7A-7C can be pivotable or pivoted to an open orientation to provide clearance for overhead solar panel insertion into the support channels, and upon insertion, the panel mounts can then be pivoted to a closed orientation upon application of a downward force, such as to the solar panel.

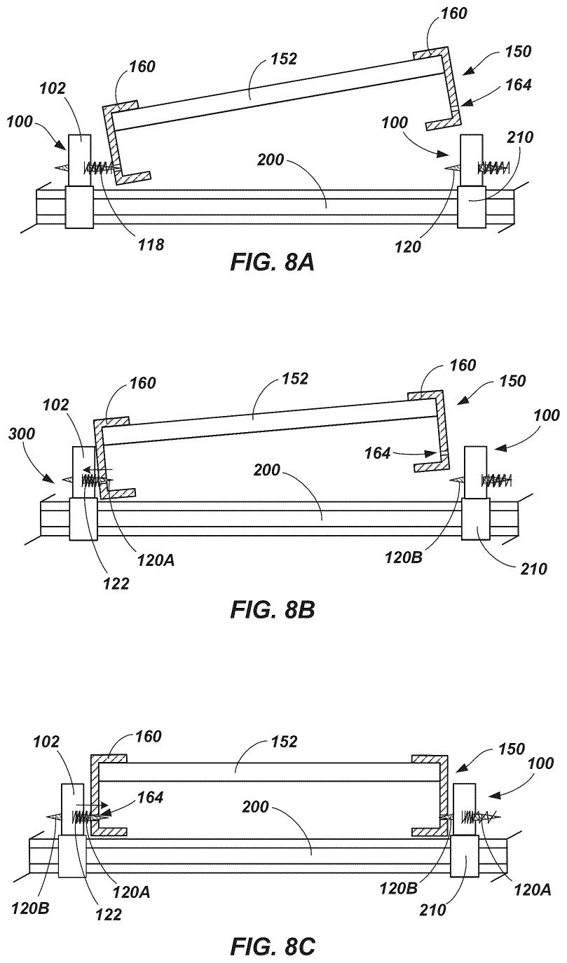

Referring now to FIGS. 8A-8B, another solar panel mounting system is shown that is suitable for angled overhead insertion of a solar panel 150 between two panel mounts 100, each of which is mounted on a torque tube clamp 210, both of which are mounted on a torque tube 200. In this example, the solar panel is shown with its solar panel element 152 supported by a support frame 160, shown in cross-section. One of the panel mounts includes a first (longer) fixed pin 120A associated with a spring 122, and at an adjacently installed panel mount (or on the other side of the same panel mount), the panel mount may be equipped with a second (shorter) fixed pin 120B. Notably, the first pin may be a fixed pin with a different type of biasing structure present along the panel mount, e.g. such as the biasing structure 106 shown in FIGS. 3A. In other words, the spring may or may not be associated directly with the first fixed pin, but may be operationally associated therewith to bias a solar panel being installed toward the second fixed pin. In other words, on one side, there may be a pin and a biasing structure, with the spring positioned about the pin (as shown) or as a separate structure located along a face of the panel mount. Thus, the pin itself may or may not be associated directly with the spring. In this example, the solar panel may be installed first on the longer first fixed pin, and the spring (wherever it is positioned) may provide a biasing or springing force away from that side and toward an adjacently installed panel mount on the other side of the solar panel, which may be equipped with a second fixed pin, for example. In further detail, the panel support frame is equipped with panel support apertures 164 at locations suitable for receiving either the fixed pins upon angled overhead insertion of the solar panel on one side followed by dropping in the other side to align with the panel support apertures. As shown in

FIG. 8A, the solar panel is inserted into the panel mount with the first fixed pin. The first fixed pin is shaped so that when the solar panel is at least partially installed via its panel support aperture about the first fixed pin, the spring is depressed into the sufficiently to provide enough clearance for the other panel mount to pass by the fixed pin, as shown in FIG. 8B. The spring force of the spring (or other biasing structure) pressing the solar panel toward the second (shorter) fixed pin allows for both pins (one on each side) to remain seated within their respective panel support apertures, as shown in FIG. 8C. Thus, in this example shown, there may be a first retaining feature in the form of a first fixed pin and a second retaining feature in the form of a second fixed pin that is shorter than the spring-loaded pin. In this example, however, there is another retaining feature in the form of a biasing structure or spring on at least one side. There may also be retaining channels present, which are not shown in this example, but are shown by way of example in FIGS. 3A-3C. It is also noted that although the solar panel is shown as being supported by a support frame, the solar panel could just as likely include support rails (frameless solar panel) with corresponding panel support apertures for overhead insertion of solar panels to engage with the fixed pins, as described above.

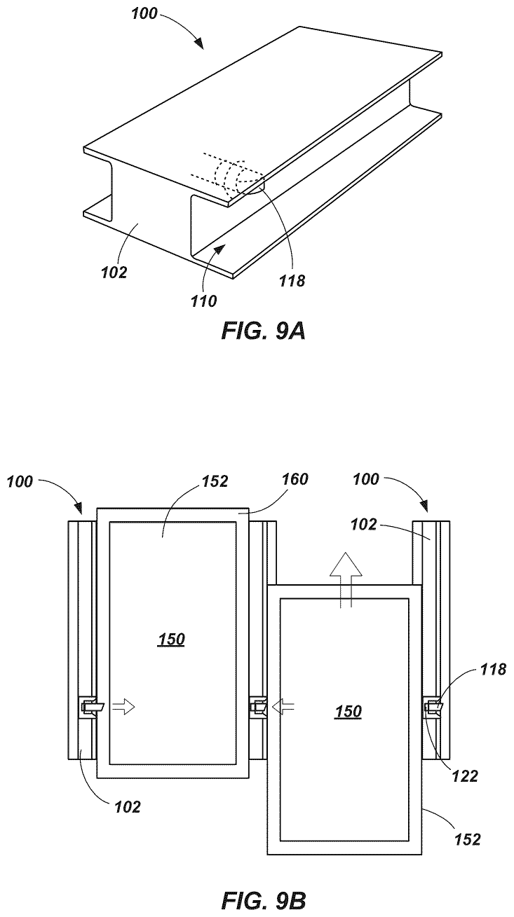

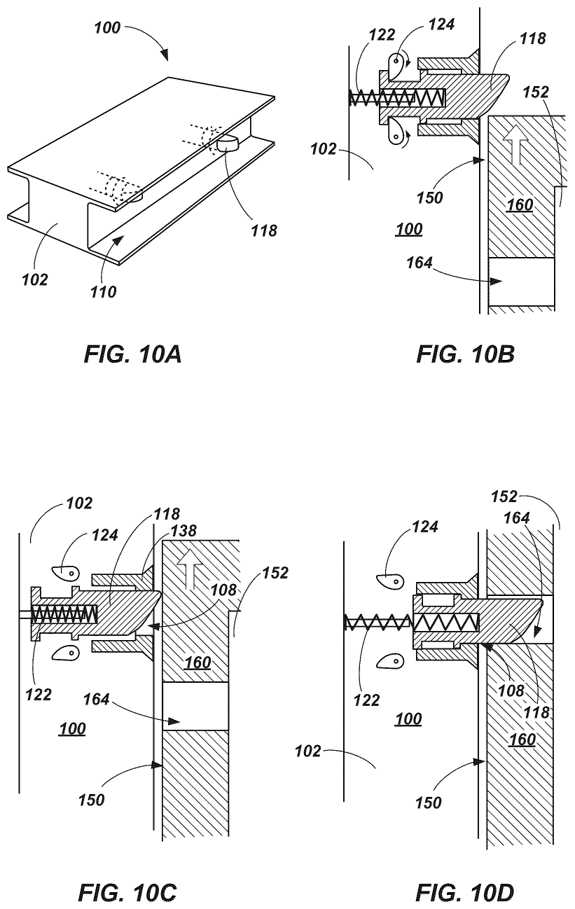

FIGS. 9A and 9B illustrate another example of a panel mount 100 that can be used on one side or both sides of a solar panel 150. In the example shown, the solar panel would have a support frame (not shown), but could likewise be supported by support rails (frameless solar panels) with minor modification of the location of the panel mounts. This example provides for lateral (slidable) insertion of the solar panel 150, e.g., lateral insertion orthogonal to the direction of the torque tube. In this example, the panel mount shown includes multiple retaining features, namely a retaining channel 110 and the inclusion of a spring-loaded pin 118. Additional detail regarding the spring-loaded pin is provided below in the example shown in FIGS. 10A-10D.

Referring now to FIGS. 10A-10D, an example of a panel mount 100 is shown that could be used on one side or both sides of a solar panel (with a support frame or support rails), which may be of particular use for slidable insertion of the solar panel 150, e.g., lateral insertion orthogonal to the direction of the torque tube. In this example, the panel mount shown includes multiple retaining features, namely a retaining channel 110 and the inclusion of spring-loaded pins 118 that can ingress and egress through a panel mount aperture 108. Notably, in this example, spring loaded pins are configured as multi-level engagement pins, meaning that in addition to the configuration where there is no elevation or engagement, e.g., completely retracted or recessed, there are multiple protruding pin elevations for engaging with the solar panel (support frame or support rail). Examples include an initial mid-level engagement elevation (See FIG. 10A), followed by a recessed elevation (See FIG. 10B) that occurs during slidable insertion of the solar panel, followed by an extended engagement elevation (See FIG. 10C) when a panel support aperture 164 of a support frame or support rail of the solar panel becomes aligned with the multi-level engagement pin, thereby allowing the multi-level engagement pin to become seated in the panel support aperture at the extended elevation. In this example, the spring-loaded pin has multiple levels of engagement with the solar panel (as well as non-engagement or full retraction) due to the presence of a spring 122, a pin-retaining feature 138, and a pin lever mechanism 124 that work together to provide the multiple elevations prior to engagement with the solar panel and then after engagement with a panel support aperture of the solar panel. As shown in FIG. 10B, prior to engagement with the solar panel, the spring-loaded pin is at its initial position, biased partially inward and held in place by the pin lever mechanism. Upon engagement with the solar panel during a slidable insertion event, as shown in FIG. 10C, the pin lever mechanism rotates out of the way. The pin lever mechanism may likewise be spring-loaded, for example. As shown in FIG. 10D, when the panel support aperture is aligned with the spring-loaded pin, the pin can become seated in the panel support aperture at its extended engagement elevation.

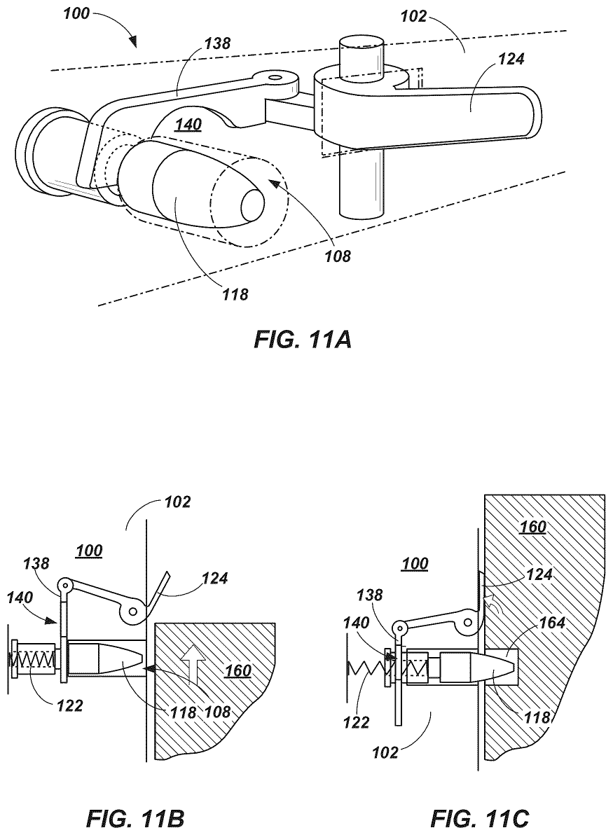

Referring now to FIGS. 11A-11C, another example panel mount 100 is shown that could be used on one side or both sides of a solar panel 150, which may be of particular use for slidable insertion of the solar panel 150, e.g., lateral insertion orthogonal to the direction of the torque tube. More specifically, FIG. 11A illustrates a perspective view of the panel mount with a spring-loaded pin 118 and a pin lever mechanism 124, FIG. 11B depicts a side plan view of the panel mount before it engages with the solar panel, and FIG. 11C depicts a side plan view of the panel mount after it engages with the solar panel. More specifically, as shown in FIGS. 11A-11C, the panel mount includes a spring-loaded pin that is biased outward, but in this instance, rather than the spring-loaded pin engaging with the solar panel as it is slidably installed, the feature that engages with the solar panel is a pin lever mechanism. The pin lever mechanism is operationally attached to a pin-retaining feature 138 that prevents the pin from protruding through a panel mount aperture 108 until the pin lever mechanism is depressed by the solar panel as it is slid past the pin lever mechanism. In this example, the pin-retaining feature has a pin-retaining feature recess 140 that allows the pin to freely pass through consistent with the bias provided by spring 122. As the spring-loaded pin is biased outward, when the pin-retaining feature recess is aligned therewith, the spring-loaded pin can enter the panel support aperture 164 when it is slid in place in alignment with the spring-loaded pin.

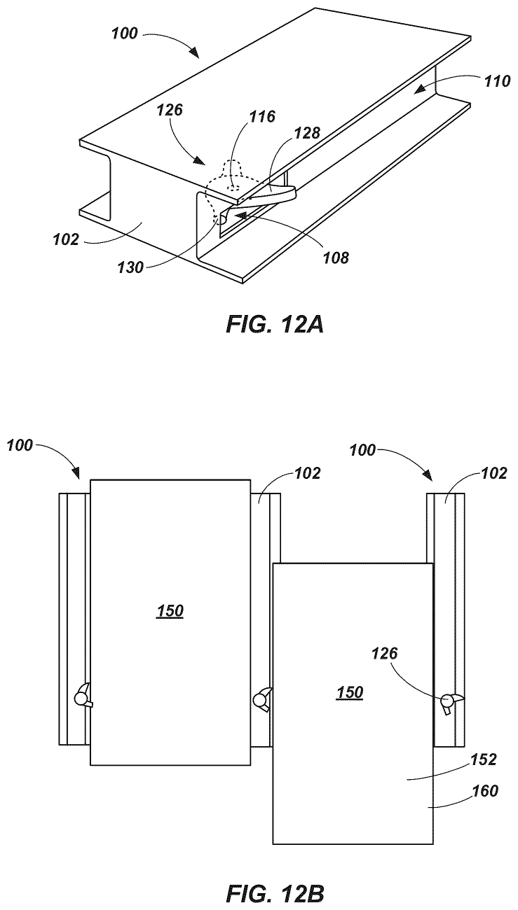

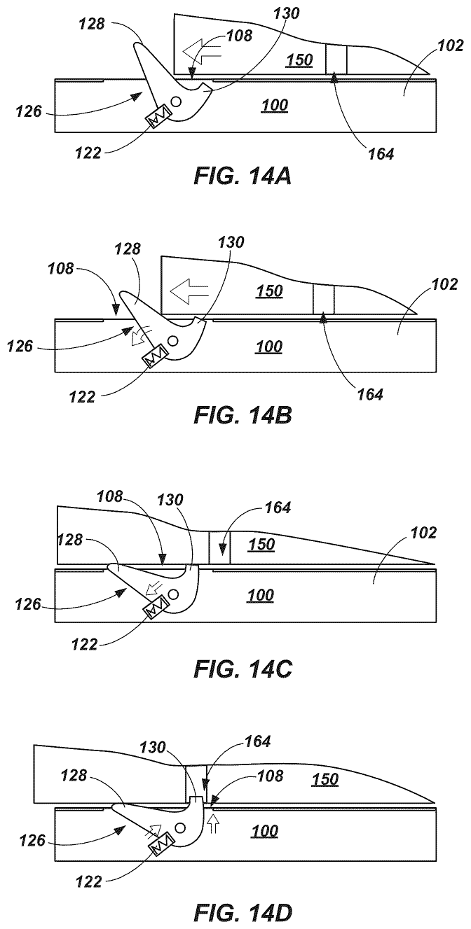

Referring now to FIGS. 12A and 12B, a perspective view of a panel mount 100 (FIG. 12A) and a top plan view of multiple panel mounts as they are engaged or are slidably engaging with solar panels 150 are shown. This particular panel mount includes two retaining features, namely a retaining channel 110, and a rotatable levered pin 126, portions of which can protrude and retract through a panel mount aperture 108. In this example, the rotatable levered pin includes a lever portion 128 that interfaces with the solar panel as it is inserted laterally through the retaining channel. The panel support (not shown, but could be either a support frame or a support rail, as shown in FIGS. 2A and 2B at 160 and 162, respectively) may include corresponding panel support apertures (not shown, but shown by example in FIGS. 10C and 10D at 164) that when aligned with a pin portion 130 of the rotatable levered pin, the solar can be held in place by this engagement. The rotatable levered pin, for example, may be spring-biased in a manner similar to that shown in FIGS. 14A-14D hereafter.

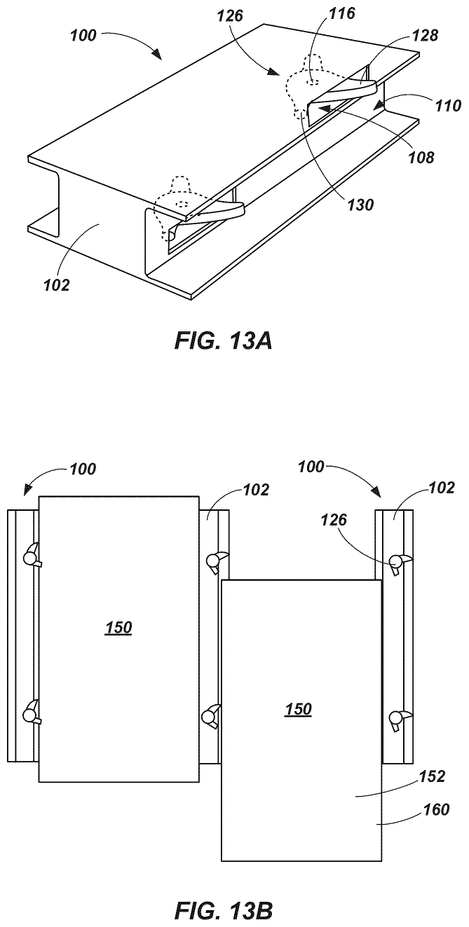

Referring now to FIGS. 13A and 13B, a similar arrangement to that shown in FIGS. 12A and 12B is provided, except that rather than two retaining features, namely the retaining channel 110 and the rotatable levered pin 126 positioned at a panel mount aperture 108, there is a third retaining feature, which is a second rotatable levered pin associate with its own panel mount aperture. The structures in this example for the second rotatable levered pin may be the same or similar to that of the (first) rotatable levered pin. Again, the panel support (not shown, but could be either a support frame or a support rail, as shown in FIGS. 2A-2B) may include corresponding panel support apertures (not shown, but shown at FIG. 10C and 10D at 164 by way of example) that when aligned with a pin portion 130 of the multiple rotatable levered pin, the solar can be held in place by these engagements, e.g., placement within the retaining channel with multiple engagements with the multiple rotatable levered pins.

Referring now to FIGS. 14A-14D, a side cutaway view of a portion of a solar panel mounting system is shown, which includes a panel mount 100 with a retaining feature embedded therein, which in this instance is a rotatable levered pin 126, portions of which can protrude and retract through a panel mount aperture 108. More specifically, FIG. 14A shows a side cutaway view of a rotatable levered pin prior to contact with the solar panel 150, FIG. 14B illustrates the rotation of the rotatable levered pin beginning upon solar panel contact during lateral (slidable) insertion, FIG. 14C illustrates the rotatable levered pin in position to allow the solar panel to pass by, and FIG. 14D illustrates the rotatable levered pin after its pin portion 130 becomes seated within a panel support aperture 164 of the support frame or support rails (not shown, but shown at 160 and 162, respectively). Thus, the rotatable levered pin includes a lever portion 128 that engages with the solar panel as it slides along a surface of the panel mount. When a pin portion becomes aligned with the panel support aperture, the pin portion enters the panel support aperture of a panel support. In this particular example, the rotatable levered pin can be spring loaded with spring 122. Thus, FIGS. 14A-14D sequentially illustrate how engagement of the solar panel with the rotatable levered pin causes the pin portion to ultimately become engaged with the panel support aperture (see FIG. 14D) to lock the solar panel in place laterally. Note that in the examples shown in FIGS. 13A-14D, the pin portion and the lever portion are located on a common rotatable levered pin.

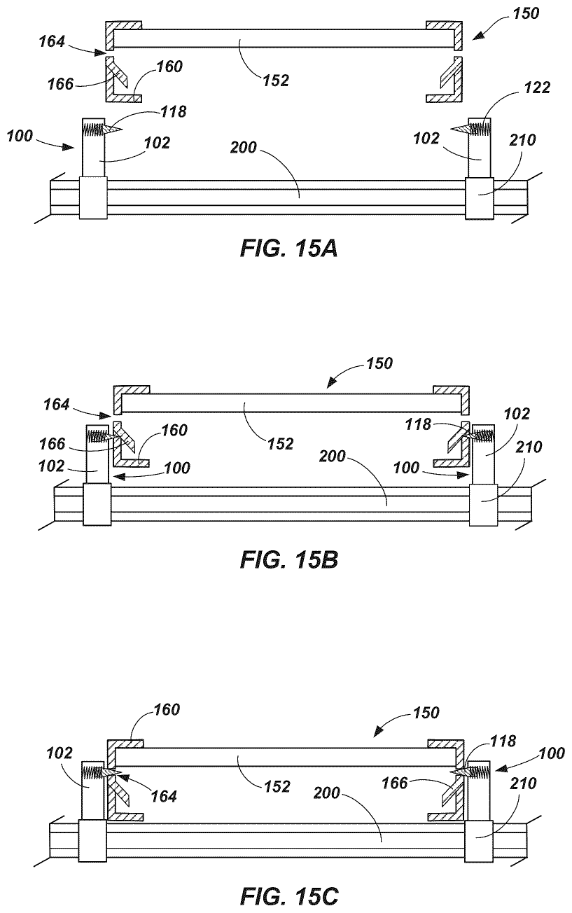

Referring now to FIGS. 15A-15C, another solar panel mounting system is shown that is suitable for overhead insertion of a solar panel 150 between two panel mounts 100, each of which is mounted on a torque tube clamp 210 with both torque tube clamps mounted on a torque tube 200. In this example, the solar panel includes a solar panel element 152 supported by a support frame 160, shown in cross-section. Both of the panel mounts include spring-loaded pins 118, which are each retractable into its respective panel mount. The panel support frame is equipped with panel support apertures 164 at locations suitable for receiving the spring-loaded pins upon overhead insertion of the solar panel. Unlike the example shown in FIGS. 8A-8C, the overhead installation does not require an angled overhead insertion of one side followed by the other side. This is because the support frame in this example includes an angled retractor feature 166 that acts to retract the spring-loaded pin that it engages with (see FIG. 15B) until the support frame is slid down far enough to align the panel support aperture with the spring-loaded pin. Thus, once the solar panel is seated (above the torque tube and between the panel mounts), the spring 122 of the spring-loaded pin can release, seating the fixed pin in its corresponding aperture, as shown in FIG. 15C. As with other examples, it is noted that although the solar panel is shown as being supported by a support frame, the solar panel could just as likely include support rails (frameless solar panel) with corresponding panel support apertures for overhead insertion of the spring-loaded pin and the fixed pin therein. Thus, in this example, there may be a first and second retaining feature, each of which includes a spring-loaded pin. The support frame or support rails of the solar panel include one or more angled retraction features to cause the spring-loaded pins to retract into the first retaining feature, the second retaining feature, or both upon overhead insertion of the solar panel. The support frame or support rails of the solar panel in this example include a plurality of panel support apertures to permit the spring-loaded pin to release from being retracted to become seated in the panel support apertures.

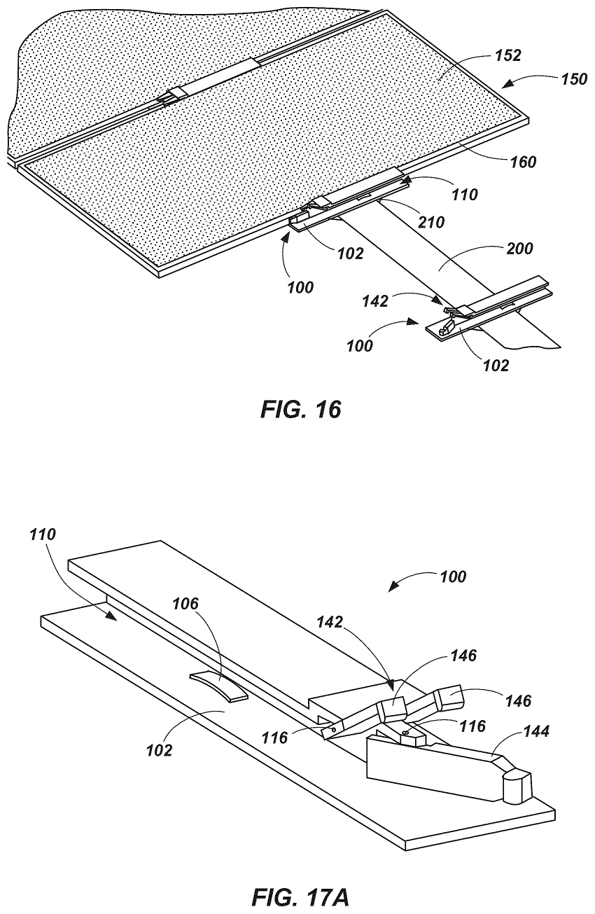

Referring now to FIG. 16, a perspective view of a series of solar panels 150 being installed in a direction parallel with a torque tube 200 is shown. The panel mounts 100 shown may be coupled with the torque tube using a torque tube clamp (not shown as being obscured by the panel mounts, but an example of a torque tube clamp is shown at 210 in FIGS. 3A-3C). In this example, the panel mounts are equipped with multiple retaining features, including lead-in latch assemblies 142 that are suitable for lateral (sliding) insertion of solar panels into the panel mounts in accordance with the present disclosure.

The term “lead-in latch” refers to a latch that includes a portion that interacts by pivoting or being deformed to receive a solar panel due to mechanical interaction with an edge or face of a solar panel frame or an edge or face of a solar panel rail. The lead-in latch can then at least partially pivot back or return from its deformed configuration, such as when the latch reaches a location along the solar panel frame, e.g., a panel support aperture or detent, where the solar panel can be locked into place by a latch protrusion, process, or pin. The lead-in latch assemblies can be mounted on a panel mount support. An additional retaining feature includes a retaining channel 110. Thus, a properly spaced adjacent pair of panel mounts are in position to receive and retain a solar panel therebetween within the retaining channels, and furthermore, may be locked into place with additional security using the lead-in latch assemblies.

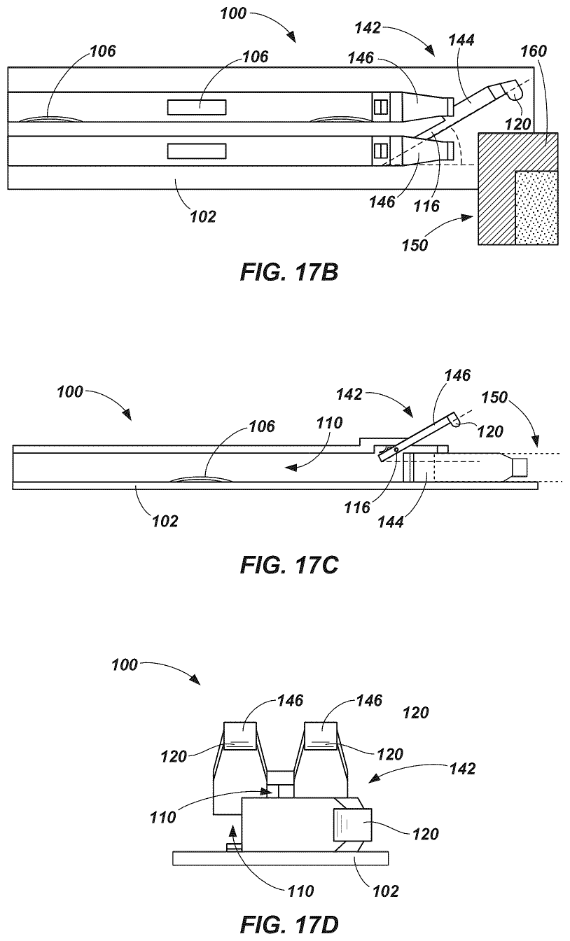

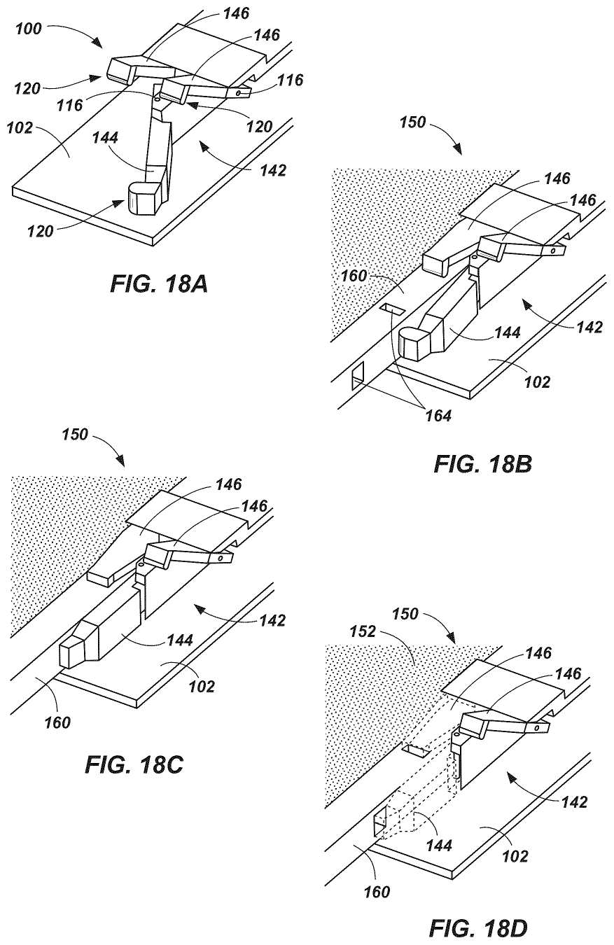

A more detailed view of a panel mount 100 is shown in FIGS. 17A-17D by way of example. FIG. 17A provides a perspective view of the panel mount, FIG. 17B illustrates a top plan view of the panel mount as the solar panel 150 is being slidably inserted, FIG. 17C illustrates a side plan view of the panel mount as the solar panel is being slidably inserted, and FIG. 17D provides an end view of the panel mount to show the elevations of the various retaining features. As mentioned in FIG. 16, the retaining features of this example include a lead-in latch assembly 142. In greater detail, the assemblies can include an edge lead-in latch 144 to engage with panel support apertures (not shown, but shown in FIGS. 18A-18D hereinafter) positioned along an edge of a support frame 160 of the solar panel or along an edge of a support rail (not shown) and two facial lead-in latches 146 to engage with panel support apertures (not shown, but shown in FIGS. 18A-18D hereinafter) positioned along a facial surface (the planar surface) of the support frame (not shown). Notably, one of the facial lead-in latches is used at the opposite edge of the next solar panel to be installed. This example also includes another type of retaining feature, namely a retaining channel 110 that is equipped with biasing structures 106 to provide a snug fit to the solar panel while being laterally (slidably) inserted and also a snug fit after full insertion into the panel mount. Furthermore, both the edge lead-in latch and the facial lead-in latches are positioned on the panel mount support 102 individually via a panel mount support pivot 116 such that when the solar panel is slid into place, a lever arm protruding into the retaining channel is engaged, and by lever action, an engagement protrusion 120 (which operates similar to a pin for engagement with a panel support aperture described previously) on the lever arms pivots toward the support frame (or support rail) to engage with the panel support apertures.

FIGS. 18A-18D illustrate an example sequence of operation of a panel mount with the lead-in latch assembly described in FIGS. 23-17D above. More specifically, FIG. 18A illustrates a panel mount 100 including a panel mount support 102 connected to three lever arms via panel mount support pivots 116 as the retaining features, which include an edge lead-in latch 144 and two facial lead-in latches 146 as part of a lead-in latch assembly 142. Each of the lead-in latches is equipped with an engagement protrusion 120 that will align with various panel support apertures 164 when the solar panel is slid into place through the retaining channel 110.

FIG. 18B, in particular illustrates the edge lead-in latch 144 and one of the facial lead-in latches 146 being partially actuated as the support frame 160 of the solar panel 150 slides through the retaining channel (not shown, but shown in FIG. 17D at 110). Since the panel support apertures 164 have not reached the engagement protrusions 120 at this point during solar panel insertion, the engagement protrusions slide along the two support frame surfaces shown, generating some pressure against these two support frame surfaces as well as against the panel mount support.

FIG. 18C illustrates the solar panel 150 once the engagement protrusions 120 of the edge lead-in latch 144 and one of the facial lead-in latches 146 reaches their respective panel support apertures 164. Once the engagement protrusions drop into two panel support apertures due to pressure being relieved by the support frame 160 (or support rail, not shown), the solar panel becomes locked in place along two different orthogonal surfaces of the support frame, generating a secure and stationary installation.

FIG. 18D also illustrates the solar panel 150 locked in place along its support frame 160, but in this example, the other of the facial lead-in latches 146 that is still in its unengaged position is ready to accept the next solar panel to be installed. Notably, on this (second) side of the panel mount, there is not an edge lead-in latch, but there could be with a little bit more separation between adjacently installed solar panels. However, with this configuration, if an identical or similar panel mount is installed along the torque tube at a distance suitable for installation of another solar panel, then the other side of the next solar panel installed would likewise benefit from engagement of both an edge lead-in latch 144 and a facial lead-in latch 146 with the support frame at its panel support apertures. Thus, on one side of each panel, the lead-in latch assembly 142 would engage with the support frame at two panel support apertures and on the other side of each panel, the lead-in latch assembly 142 would engage with the support frame at one panel support aperture. Stated another way, each panel mount shown in this example includes a first side with two lead-in latches, e.g., an “edge” lead-in latch and a “facial” lead-in latch, and a second side of each panel mount includes one lead-in latch, e.g., a “facial” lead-in latch (for receiving one side of an adjacent solar panel).

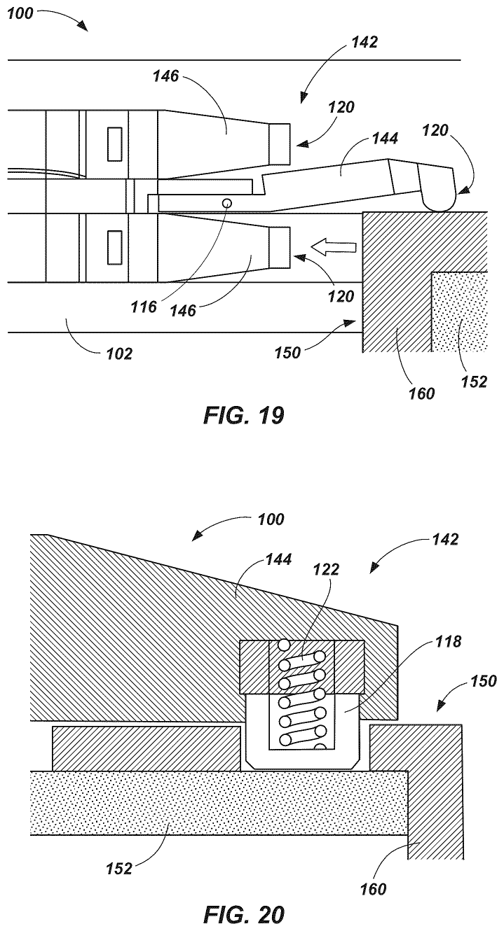

Referring now to FIG. 19, an alternative example panel mount with a lead-in latch assembly 142 is shown where the edge lead-in latch 144 and the facial lead-in latches 146 deform elastically. Thus, a panel mount support pivot may or may not present in this example, as the material of lead-in latches may provide enough resilient elasticity to deflect while inserting the solar panel 150. However, in some examples, the panel mount support pivot 116 (or ground pivot) may still be present to provide a force on the opposite side of the pivot to push the latch into the panel support aperture. In this latter instance, the elastic deformation enables the latch slightly deform to slide along the panel until the aperture is reached. The pivot may also enable a greater degree of rotation for a larger lead-in distance, in some examples. The lead-in latches include lever arm portions that include the engagement protrusion 120 available to deflection, while the balance of the structures or the pivots are fixedly attached to the panel mount support 102, and then returned to a position suitable for becoming seated within the panel support apertures (not shown, but shown in FIG. 18B) when the panel is aligned in the correct position.

FIG. 20 illustrates a portion of an example panel mount 100 with an edge lead-in latch 144 that includes a spring-loaded engagement protrusion 118 with an internally positioned spring 122. In some examples, there may or may not be a panel mount support pivot (not shown, but shown by way of example at 116 in FIG. 19) for providing a lever mechanism. The edge lead in latch may be of rigid material or may be of a material that deforms elastically, as described also in FIG. 19). However, the engagement protrusion in this instance is in the form of a spring-loaded pin 118. In instances where there is a panel mount support pivot (or ground pivot), the pivot may provide a force on the opposite side of the pivot to push the spring-loaded pin of the lead-in latch into the panel support aperture. In some examples where the lead-in latch is equipped with elastic deformation, this will enable the lead-in latch to slightly deform (along with the spring-loaded pin being retracted) to slide along the panel until the panel support aperture is reached. Thus, some of the retraction can occur via the lead-in latch deformation and some can occur via the spring-loaded pin retraction. Either way, the spring-loaded pin can should be able to retract and/or deflect sufficiently to slide along the latch support frame (or support rail) until the panel support aperture is reached. The pivot may also enable a greater degree of rotation for a larger lead-in distance, in some examples. Any combination of these three embodiments may be used together, or each may be used separately (as shown). Likewise, these examples that utilize a lead-in latch mechanism to engage with panel support apertures may engage with a support frame 160 (supporting the solar panel element 152) of the solar panel 150 as shown in FIGS. 23-27, or may alternatively engage with support rails (not shown) of a frameless solar panel.

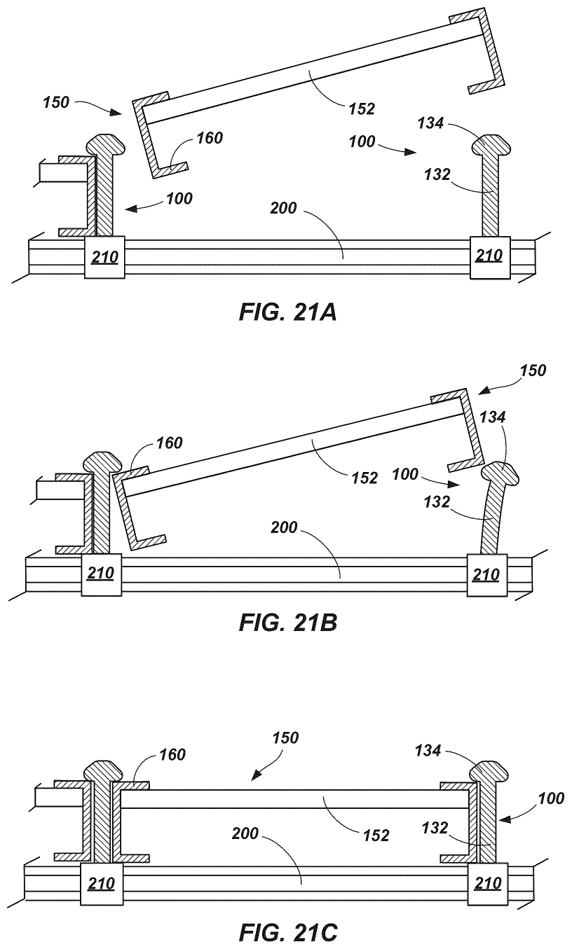

Referring now to FIGS. 21A-21C, another example solar panel mounting system is shown. In this example, the panel mount 100 includes flexible features to allow for overhead insertion of the solar panel 150. As with the other example, the solar panel may include a solar panel element 152 mounted on a panel support, which in this instance is a support frame 160, but could be support rails 162 in the case of a frameless solar panel. The flexible features in this example may include a retaining feature with a flexible structure or portion 132 and a retaining button 134. The retaining features in this example are attached to torque tube clamps 210, which are mounted on a torque tube 200. In the example shown in FIG. 21A, a previously installed solar panel is present, which is pressed firmly up against one of the panel mounts, preventing the immediately adjacent panel mount from flexing in a direction toward the previously installed solar panel. Thus, when installing the next solar panel from above, the solar panel may be inserted at a slight angle into one of the panel mounts, as shown in FIG. 21B, and the other panel mount can be flexed in an outward direction relative to the solar panel to allow for insertion of the other side of the solar panel, as shown in FIG. 21C. However, it is noted that the solar panel could likewise be installed directly from above (or flat installation) at no angle, simultaneously instilling the panel between the two flexible features of the panel mounts simultaneously. Notably, with the prior solar panel already in place, when installing directly downward without the angle, most or all of the deflection would occur at the panel mount that does not already have a solar panel installed. Once the solar panel is installed between both panel mounts, the next solar panel may be installed (not shown). Thus, in the example shown, a first retaining feature, a second retaining feature, or both may be flexible and include a retaining button 134 positioned to receive and retain a support frame or a support rail of a solar panel. The retaining button can be positioned to retain the support frame 160 above the solar panel 150, as shown in FIGS. 21A-21C.

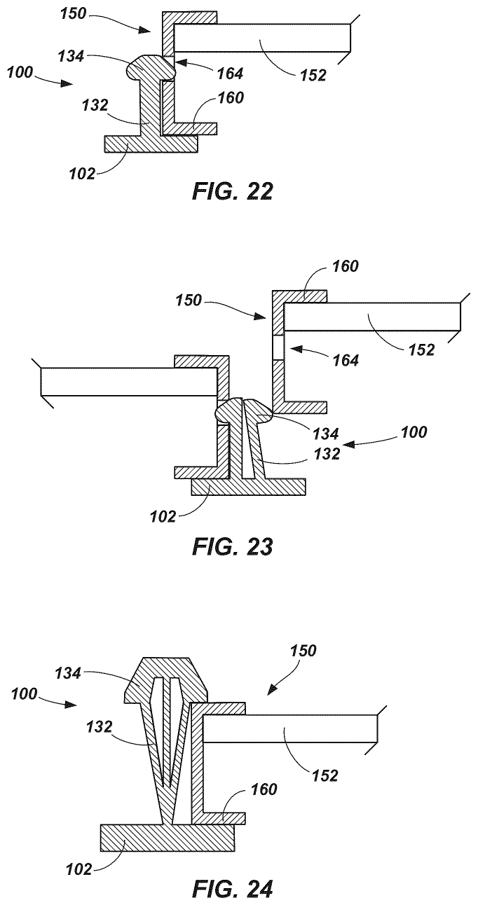

In other examples, the retaining button 134 may be positioned to retain the support frame 160 (or support rails, not shown) at a panel support aperture 164 along a side surface of the solar panel 150, such as that shown in FIGS. 22 and 23. FIG. 22 is the same as that shown in FIGS. 21A-21C, except that the retaining feature is at a lower elevation to engage with the panel support aperture rather than the top of the support frame. FIG. 23, on the other hand, separates two different retaining features on a common panel mount, thus allowing both retaining features to flex independently. This arrangement is suitable for flat overhead installation or angled overhead insertion. In another example, FIG. 24 is arranged similar to that shown in FIGS. 21A-21C, except that this design allows the panel mount a degree of side to side deflection or even to “bow” inward to account for tolerances when installing overhead. Each of these example panel mounts 100 include reference numbers that correspond to those set forth in FIGS. 21A-21C and elsewhere herein.

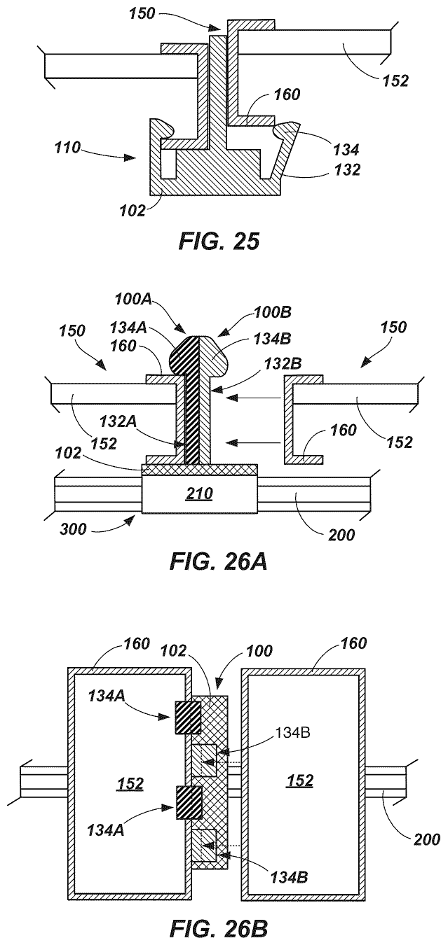

FIG. 25, as shown, illustrates an example solar panel mounting system similar to that shown in FIG. 23, except that rather than being configured to engage with the top of the support frame 160 above the solar panel 150, it allows for engagement with a bottom portion of the support frame or even a similar feature that may be present beneath a support rail (not shown) of a frameless solar panel. As shown, the panel mount is suitable for engagement with two adjacent solar panels, with a first and a second retaining feature, each including a flexible structure or portion 132 and a retaining button 134.

Referring now to FIGS. 26A and 26B, a solar panel mounting system is shown that includes multiple retaining features 100 that are laterally offset in a direction orthogonal with the torque tube 200 when attached thereto via the torque tube clamp 210. FIG. 26A illustrates a side plan view of one solar panel 150 in place and a second solar panel being inserted. Again, in this example, the solar panel 150 includes a solar panel element 152 and a support frame 160 but could alternatively include support rails instead. This arrangement allows for installing solar panels in closer proximity with one another, e.g., smaller gap between adjacent solar panels. The panel mounts in this example include retaining features in the form of flexible structures or portions 132A and 132B which support retaining buttons 134A and 134B. Installation may be carried out by overhead insertion of the solar panels with a downward or orthogonal force relative to the upper planar surface of the solar panel.

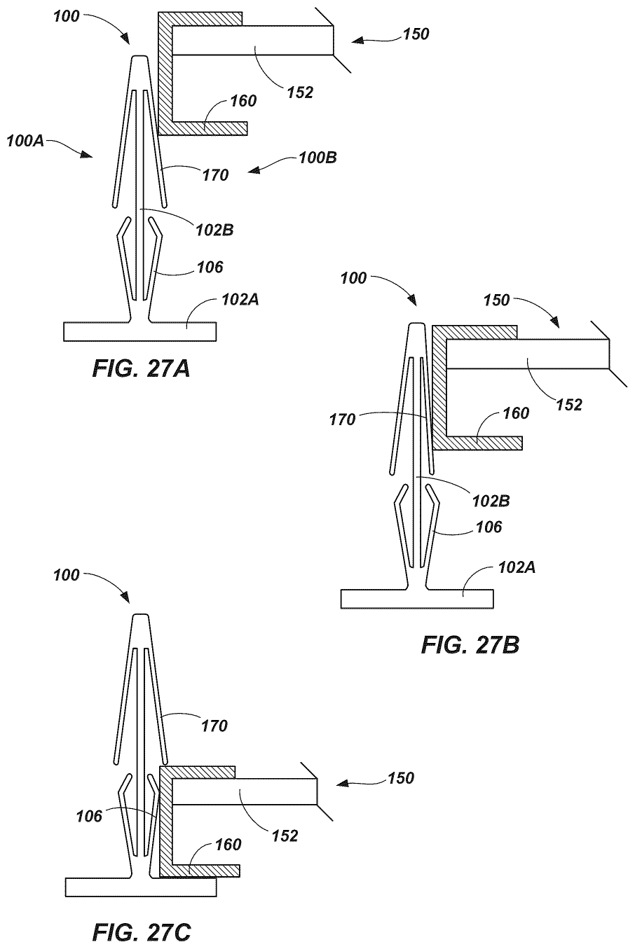

FIGS. 27A-27C illustrate another example of a flexible panel mount 100 at various stages of insertion of a solar panel 150. As shown, the solar panel includes a support frame 160 and a solar panel element 152. FIG. 27A in particular illustrates one side of the solar panel prior to being inserted between two panel mounts (the panel mount on the opposite side of the solar panel is not shown). The panel mount includes a panel mount support 102, which includes a support base 102A and a support column 102B. The panel mount includes two different types of flexible structures, namely a flexure lock 170 and a biasing structure 106. The panel mount includes similar structures on both sides, each side for engaging adjacently installed solar panels. As with many of the other FIGS., only one side of the panel mount is depicted as being engaged, as the solar panels would typically be installed sequentially.

FIG. 27B illustrates the panel mount 100 as the solar panel 150 is being installed using overhead insertion, which may be by a flat or direct overhead insertion (as shown) or may be an angled overhead insertion (not shown, but shown by way of example at FIGS. 21A-21C, for example). As the solar panel is being installed between the solar panel mounts by a downward force (relative to the support base 102A), the flexure lock 170 becomes depressed, which may create some tension against the edge of the solar panel frame 160 while the solar panel is being installed between two adjacently installed panel mounts.

FIG. 27C illustrates the panel mount 100 once the solar panel 150 has been fully seated between two adjacent panel mounts, with a biasing structure 106 being depressed to provide some tension against the solar panel frame 160. The biasing structure in this example is also a flexure element, which includes an arrowhead configuration so that compression can be controlled when the biasing structure becomes abutted against the support column 102B of the panel mount support 102. When fully seated, the flexure lock is allowed to return to its prior non-retracted position, thus locking the solar panel frame into place with vertical retention (relative to the support base 102A) against the support base. With a similar panel mount positioned on the other side of the solar panel, the biasing structure (or arrowhead flexure) provides a mechanism for horizontal centering of the solar panel between the adjacent panel mounts.

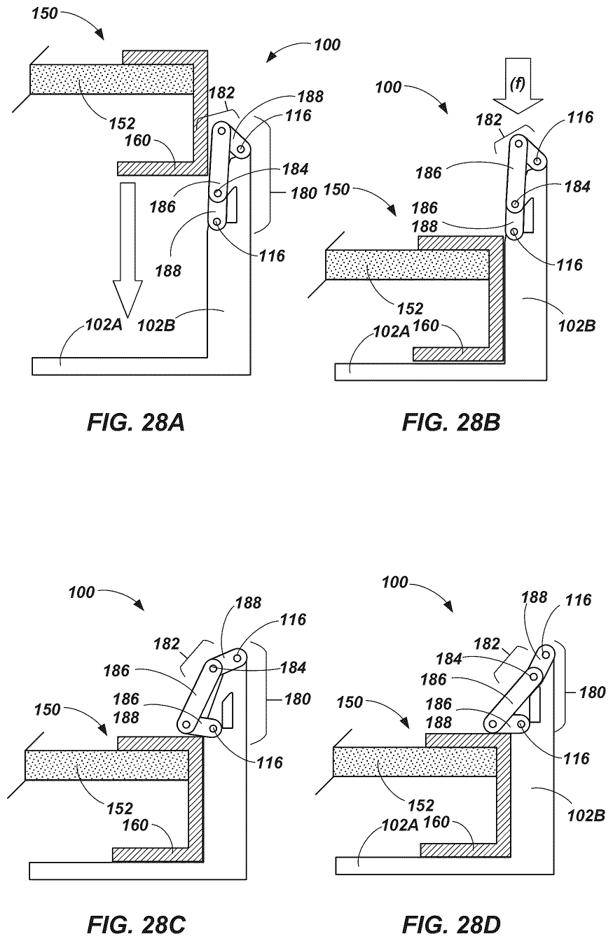

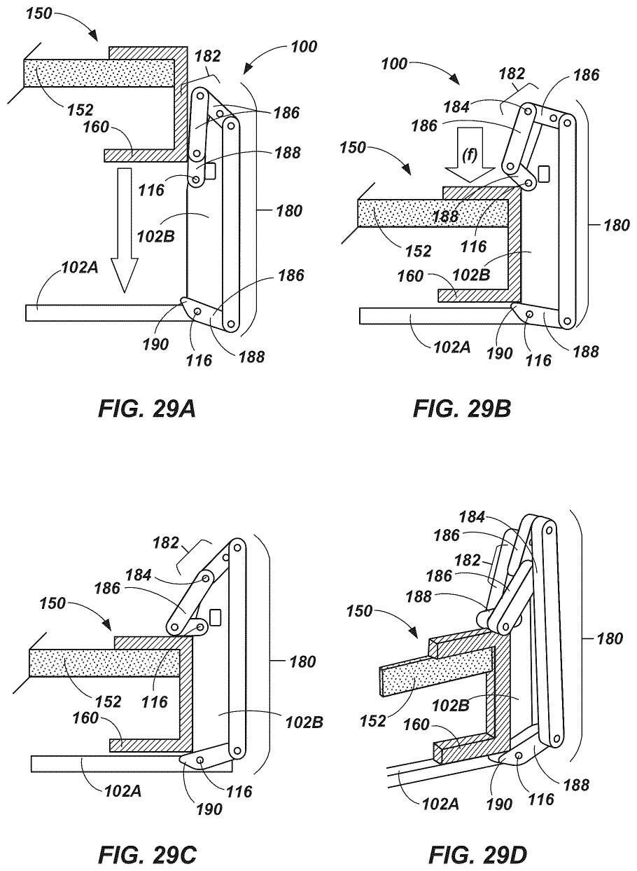

Referring now to FIGS. 28A-28D and FIGS. 29A-29D, two alternative panel mounts 100 are shown that utilize an over-center linkage assembly 180 as a retaining feature to lock solar panel 150 in place. The solar panel is shown with a solar panel element 152 and a support frame 160. The over-center linkage assemblies of both examples include multiple panel mount support pivots 116 (or ground pivots) coupling opposite ends of the over-center linkage assemblies to a panel mount support, which includes a support base 102A and a support column 102B, as well as an over-center linkage with an over-center pivot 184. It is appreciated that though this panel mount support only shows one side of the panel mount, this panel mount could likewise be bi-directional to provide a locking mechanism to another solar panel being installed adjacent to the solar panel using the same panel mount. Additionally, as with many of the other FIGS., only one side of the solar panel is depicted as being engaged, and an adjacently positioned panel mount positioned along the torque tube (not shown) via a torque tube clamp (not shown) at a distance of about a panel width from the panel mount shown is shown.

Regarding FIGS. 28A-28D in particular, the panel mount 100 includes two panel mount support pivots, or ground pivots 116 being attached to a support column 102B of the panel mount support 102. The ground pivots provide for rotational movement to respective ground bars 188. The term “ground” in this instance refers to the pivots and bars that are coupled directly to the panel mount support, which are the structures that ground the balance of the over center linkage assembly to the panel mount support. FIG. 28A in particular illustrates one side of the solar panel 150 prior to being inserted between two panel mounts (the panel mount on the opposite side of the solar panel is not shown). Thus, the over-center linkage assembly is configured to receive the solar panel by overhead insertion, which may be a flat or direct overhead insertion (as shown) or may be an angled overhead insertion (not shown, but shown by way of example at FIG. 3A-4D and/or FIGS. 6A-6B). Notably, as there are three links or bars in this example, it is notable that two of the bars are part of the over-center linkage 182 and one of those two bars is attached to a ground pivot 116 of a ground linkage, which includes a ground bar 188. Thus, the ground bar (labeled both as 186 and 188) is also an over-center bar associated with the over-center linkage in this instance. FIG. 28B illustrates the solar panel after it has been dropped into place being supported below by the support base 102A. In this position, the solar panel is in position to be locked into place. FIG. 29C illustrates the latching force (f) that may be applied to the over-center linkage 182 at about the over-center pivot joint 184, such that when two over-center bars 186 attached to the over-center pivot joint are rotated beyond alignment, one or both of the over-center bars come to rest against the panel support column. In this example, there are three bars or links, with a third bar providing the interface with the solar panel to lock the solar panel between the over-center linkage assembly and the support base of the panel mount support, as shown in FIG. 28D.

Regarding FIGS. 29A-29D in particular, the panel mount 100 also includes two panel mount support pivots 116 (ground pivots), however one of the panel mount support pivots is attached to the support column 102B and the other is attached to the support base 102A of the panel mount support 102. Additionally, rather than only three bars or links, this example includes five bars or links. FIG. 29A in particular illustrates one side of the solar panel 150 prior to being inserted between two panel mounts (the panel mount on the opposite side of the solar panel is not shown). Thus, the over-center linkage assembly is configured to receive the solar panel by overhead insertion, which may be a flat or direct overhead insertion (as shown) or may be an angled overhead insertion (not shown, but shown by way of example at FIG. 3A-4D and/or FIGS. 6A-6B). Rather than the solar panel being supported from beneath directly by the support base, instead one of the ground pivots 116 associated with the support base includes an extended lever arm 190 which contacts the lower facial surface of the solar panel frame 160.

Thus, at this point, the solar panel is not resting directly on the support base. FIG. 29B illustrates a first rotational movement of over-center linkage assembly 180 that occurs to put the over-center linkage assembly in position for locking the solar panel in place. That first rotational movement occurs as the solar panel is pressed downward against the extended lever arm using a first force (f). This force could be an applied force from an installer or from an automated panel insertion device or vehicle, or this force could be provided simply by the weight of the solar panel, for example. Rotation of the lever arm in this instance causes the ground bar associated with the support base to rotate about its panel mount support pivot 116. In other words, the downward lever action causes the bar immediately adjacent to the support base ground linkage (which includes a ground bar 188) to be forced upward, thus causing the balance of the bars, including the bars associated with the ground pivot 116 and the over-center linkage 182, to rotate into position suitable for locking the support column ground linkage against an upper facial surface of the solar panel frame. As shown in FIG. 29C, in some instance, a latching force may be applied to the over-center linkage 182 at about the over-center pivot joint 184 so that the over-center bars 186 may be rotated beyond alignment until one or both of the over-center bars come to rest against the support column. FIG. 29D, which is shown as a perspective view for additional clarity, illustrates the over-center linkage at its locked over-center position against the support column, thus locking the solar panel between at least one bar of the over-center linkage assembly and the support base of the panel mount support.

In further detail regarding FIGS. 28A-29D, in some instances, at least one of the bars of the over-center linkage assembly may provide a recessed region (compared to other bars) that is suitable to provide a centering lead-in for an edge a solar panel being inserted. This can be seen to some degree in FIG. 29D where the second bar from the support column 102 (next to the upper ground bar 188) is shown as offset from the ground bar 188 and the other over-center bar 186. In other examples, in some examples, the over-center linkage 182 may be part of an at least a four bar over center linkage assembly 180, which is defined as three (or more) rotatable bars and the fixed structure, e.g. the panel mount support 102A and 102B. In other examples, the over-center linkage may be part of an at least a six bar linkage assembly, which is defined as five (or more) rotatable bars and the fixed structure. In the latter example, the six bar linkage assembly may be at least partially engageable by insertion of a solar panel onto an extended lever arm associated with a ground bar, for example.

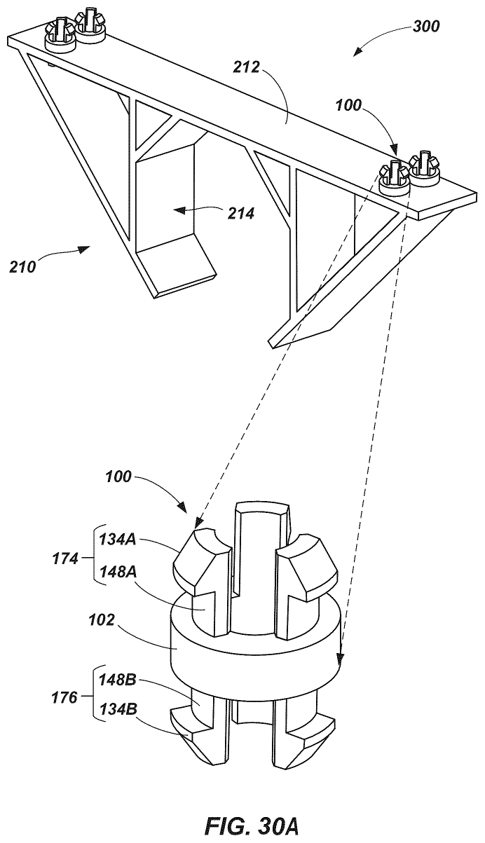

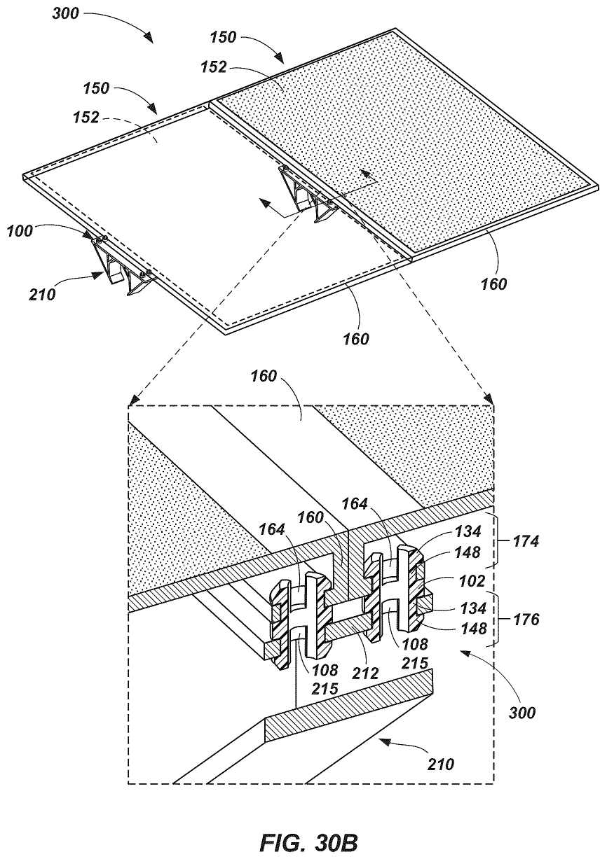

Referring now to FIGS. 30A-30B, an example panel mount 100 is shown, which is attached to a torque tube clamp 210 at a clamp support 212 thereof. The torque tube clamp is configured with a torque tube collar 214 configured for attached to a torque tube (not shown) having a cross-sectional shape of an octagon to prevent lateral rotation of the clamp when attached to the torque tube. The panel mount is shown as it is attached to the clamp support (FIG. 30A) as well as how a solar panel may be attached to the panel mount by overhead insertion (FIG. 30B).

Referring more specifically to FIG. 30A, four panel mounts 110 in the form of double-sided snaps are shown as being attached to a clamp support 212 of a torque tube clamp 210. The clamp support includes multiple clamp support apertures therethrough (not shown in FIG. 30A, but shown in cross section in FIG. 30B at 215) for receiving the double-sided snaps. More specifically, a panel mount supports 102 rests on top of the clamp support, each having a clamp-side snap 176 with a lower standoff 148B and a lower retaining button 134B. The panel mount supports (or middle rings) are configured to prevent the panel mount from passing through the clamp support apertures. Thus, the clamp-side snaps are passed through the clamp support apertures to connect the panel mounts to the clamp support of the torque tube clamp. Above the panel mount supports are panel-side snaps 174, each including an upper standoff 148A and an upper retaining button 134A. In this configuration, the panel-side snaps are individually in position to receive a solar panel at its panel mount apertures 164 during overhead installation of the solar panels. As there are two sets of panel mounts, two panel mounts are used to snap in place one side of a first solar panel, and two of the panel mounts are used to snap in the opposite side of a second solar panel, as shown in FIG. 30B.

Referring now to FIG. 30B, two solar panels are shown at 150, each including a solar panel element 152 (one shown in phantom lines for visibility beneath the solar panel) and a solar panel frame 160. The solar panel frame includes multiple panel mount apertures 164. Notably, in an example where the solar panel is a frameless solar panel supported by support rails (not shown, but shown in FIG. 2A), the panel mount apertures would be located in the support rails and the panel mount would be configured to align with the apertures of the support rails. As can be seen in this FIG., the panel mounts, which are in the form of double-sided snaps, are configured to engage the clamps support apertures 215 at its clamp-side snap and also engage the panel mount apertures 164 at its panel-side snap. The retaining buttons 134 are configured to be able to pass through their respective apertures due to an inward flex of the standoff structure, which can be flexible due to its relative thickness compared to the retaining buttons, e.g., the standoff are thinner than the retaining buttons, as well as the choice of material, for example. In this example, the sloping retaining buttons can assist with causing the standoffs in deflecting inward so that the portions above and below the panel mount support (or middle ring) can pass through their respective apertures. In this example, removal of the solar panels can be carried out by compressing the retaining buttons inward circumferentially, if there is a need to remove a solar panel from a solar panel array. Notably, the clamp support apertures are also notated by reference numeral 108, indicating examples where the clamp support acts as a base support of the panel mount, e.g., when the panel mount and the torque tube clamp are integrated as a single unit.

Furthermore as with other examples herein, these double-sided snap panel mounts 100 can be preinstalled onto the clamp support 212 (or panel mount support, notated by 108) of the torque tube clamp 210, or can be installed at the same time or just prior to installation of the solar panels. Notably, with this arrangement, adjacent solar panels can be placed in close proximity to one another because there is not support column, per se, in this example as part of the panel mount assembly.

### Methods of Installing Solar Panels

In accordance with examples of the present disclosure, a method of installing solar panels can include coupling a plurality of torque tube clamps at multiple locations along an elongated torque tube, and individually coupling a plurality of panel mounts to the plurality of torque tube clamps. The panel mounts can be oriented transversely, e.g., orthogonally, with respect to the torque tube, and the panel mounts can each include a retaining feature configured to engage with a support frame or support rail of a solar panel. In further detail, the method can include installing a plurality of solar panels to engage with retaining features of multiple panel mounts positioned adjacent one another in a direction along the torque tube without the need of separate hardware or fasteners other than retaining features integrated as part of the panel mounts.

In other examples, methods of installing solar panels can include inserting a first solar panel and a second solar panel into any of the panel mount clamp assemblies described herein in order to secure the first solar panel with the first retaining feature and to secure the second solar panel with the second retaining feature.

In some examples, the plurality of panel mounts can be individually coupled to the plurality of torque tube clamps prior to coupling the plurality of torque tube clamps to the elongated torque tube. In other examples, the plurality of panel mounts can be individually coupled to the plurality of torque tube clamps after coupling the plurality of torque tube clamps to the elongated torque tube. In still other examples, the plurality of panel mounts can be coupled to the plurality of torque tube clamps during manufacturing as an inseparable monolithic structure.

Regarding the retaining features, they may be in any of a number of forms or combinations of forms. In some examples, the retaining features can include retaining channels. In other examples, the retaining features can include a biasing structure, which may be within the retaining channels. In further detail, a first retaining channel on one side of the solar panel can be defined to include three channel walls, with a lower channel wall oriented transversely, e.g., orthogonally, relative to a rear channel wall, and an upper channel wall angled at greater than about 95° relative to the rear channel wall. Thus, in this configuration, the upper channel wall can be configured to receive the solar panel from overhead at an angle of insertion greater than about 5° relative to the orientation of the first channel wall. In other examples, one or both of the retaining channels may be pivotable or pivoted to an open orientation to provide clearance for overhead solar panel insertion into one or both of the retaining channels and wherein upon insertion, one or both of the retaining channels are pivotable to a closed orientation upon application of a downward force. In other examples, one or both of the retaining channels can be pivotable to the closed position upon application of the downward force applied to the solar panel during overhead insertion. In additional detail, the panel mounts can be cantilevered orthogonally relative to the torque tube.

In other examples, there may be multiple retaining features positioned adjacent one another on separate panel mounts and can include a first retaining feature on one side of the solar panel that includes a spring-loaded pin and a second retaining feature on the other side of the solar panel that includes a fixed pin that is shorter than the spring-loaded pin. In this example, the solar panel can include a support frame or support rail(s) with corresponding panel support apertures for overhead insertion of the spring-loaded pin and the fixed pin therein. An example is illustrated in FIGS. 8A-8C. In other examples, panel mount(s) may include a multi-level engagement pin for slidable insertion of the solar panel between a first panel mount and a second panel mount. An example of the multi-level engagement pin is shown in FIGS. 10A-10C. In some examples, in operation, the multi-level engagement pin can include an initial mid-level elevation, followed by a recessed elevation that occurs during slidable insertion of the solar panel, followed by an extended elevation when a panel support aperture of a support frame or support rail of the solar panel becomes aligned with the multi-level engagement pin, thereby allowing the multi-level engagement pin to become seated in the panel support aperture at the extended elevation. In still other examples that may utilize a spring-loaded pin(s), a support frame or support rail(s) of the solar panel can include one or more angled retraction features to cause the spring-loaded pins to retract into the retaining features positioned adjacent one another upon overhead insertion of the solar panel. In this example, the support frame or support rails of the solar panel can also include a plurality of panel support apertures to permit the spring-loaded pin to release from being retracted to become seated in the panel support apertures. An example of this is illustrated in FIGS. 15A-15C.

There are other retaining features associated with panel mounts that can be used, such as other spring-loaded pins that are associated with a pin lever mechanism. For example, a pin coupled with a pin lever mechanism can be configured in a manner shown and described in FIGS. 11A-11C. As described in this example, the spring-loaded pin is operably coupled to the pin-lever mechanism, but in some instances, the pin-lever mechanism and the pin may be present on a common structure, such as that shown in FIGS. 13A-14D. In these two examples, the pin and the pin lever mechanism are both present on a common rotatable levered pin, and in the latter example, the pin is a spring-loaded pin. For example, when the lever mechanism is actuated by a solar panel during slidable insertion between the retaining features positioned adjacent one another on either side of the solar panel, the spring-loaded pin exhibits force against a support frame or a support rail of the solar panel until a panel support aperture of the support frame or support rail seats the spring-loaded pin in the aperture.

In other examples, engagement with retaining features of multiple panel mounts positioned adjacent one another can include the use of panel mounts with flexible structures, such as one or more panel mounts having a flexible portion and a retaining button positioned to receive and retain a support frame or a support rail of a solar panel. For example, the retaining button can be positioned to retain a support frame above the solar panel, to retain the support frame at a panel support aperture along a side surface of the solar panel, or to retain a support rail of a frameless solar panel. Examples of certain arrangements with flexible structures associated with panel mounts are shown in FIGS. 21A-27B, which are not inclusive of all of the possible arrangements. In further detail, FIGS. 26A-27B illustrate another arrangement where each side of the solar panel being installed includes multiple panel mounts, and the multiple panel mounts in this example are offset laterally in a direction orthogonal with the torque tube when attached thereto via the torque tube clamp. This can allow for less space between adjacently installed panels, for example.

As can be seen in FIGS. 3A-29D, there are multiple ways of installing the solar panels between adjacently installed panel mounts, namely by overhead installation or insertion, by lateral or slidable installation or insertion, or by hybrid installation or insertion where both sliding and dropping the solar panel in place occur, e.g., one edge of a solar panel is slid along a panel mount on one side and then the other side is dropped in to an adjacent panel mount from overhead. Automated tooling may be used for either installation method, or alternatively, the solar panels may be installed manually. In many examples, the solar panels may be installed without the need for additional hardware to secure the solar panels between adjacent panel mounts, e.g., no need for using other types of fasteners (screws, rivets, nails, glue, etc.) to secure the solar panels in the panel mounts. Regarding overhead installation, depending on the panel mounts selected for use, in some instances, the solar panels can be installed by a flat or direct overhead insertion procedure, where both the leading edge and the trailing edge (in the direction of installation) of the solar panels are installed simultaneously. On the other hand, some overhead installation approaches may benefit from approaching the panel mounts with the solar panels at an angle, inserting one side first followed by the other. This is also considered overheard installation. As mentioned, hybrid installation may use one panel mount as a slidable guide and then the other side is dropped in from overhead. Regarding lateral slidable installation or insertion of the solar panels, in these examples, the solar panel is typically engaged with two adjacent panel mounts from the side at the same time, and the solar panel is slid laterally into place between the retaining features of the respective panel mounts. Notably, even though several FIGS. and descriptions here illustrate one type of installation or insertion, these can be modified for other types of installation or insertion with minor adjustments, including those described in other examples. For example, a slidable installation embodiment could be modified by removing the retaining channel on one side or by modifying a retaining channel to include an angled top for overhead angled insertion or hybrid insertion. The automation devices and/or vehicles selected or designed for use with these systems may dictate how each embodiment is configured.

### Definitions

As used herein, the singular forms “a,” “and,” “the,” etc., include plural referents unless the context clearly dictates otherwise.

As used herein, the term “panel mount” refers to a structure or an assembly of structures that is adapted to receive and retain solar panels in an operationally installed position. In some examples, the panel mount includes one or more retaining features, such as a retaining channel, a spring-loaded pin, a flexible structure with a retaining button, a pivoting structure, a biasing structure, a lead-in latch, an over-center linkage, or the like. A plurality of panel mounts can be operable together to provide for sequential installation to form a line of solar panels along a torque tube, or an array of solar panels, for example. The installation of a solar panel along the torque tube typically utilizes two torque tube clamps, each attached to inward facing panel mounts. A panel mount may include multiple retaining features configured to engage with two adjacently installed solar panels, with a first retaining feature to receive a first end of a first solar panel and a second retaining feature to receive a second (opposite) end of a second solar panel. The other side of each of the panel mounts that are not utilized to receive the solar panel are available for receiving immediately adjacent solar panels, e.g., two panel mounts would interface with three solar panels, with the center solar panel engaged on both sides and the other two engaged by the retaining features on the other side of the two respective panel mounts.

As used herein, the term “retaining feature” relates to a portion of a panel mount that directly interfaces with a solar panel in a manner that provides solar panel insertion and/or retention to the solar panel. Typically, the retaining features do not require the use of tools to engage the retaining features, making these retaining features particularly suitable for automated insertion of solar panels between adjacently placed panel mounts (which are typically clamped on a torque tube by a torque tube clamp. Example retaining features may include structures such as a biasing structure, a pin, a spring-loaded pin, a pin-lever mechanism, a flexible structure, a flexure lock, a lead-in latch assembly, an over-center linkage assembly, or the like.

A “solar panel” includes both a “solar panel element,” e.g., PV element, which is the portion of the solar panel that collects radiant energy for conversion to electrical power, and a “panel support,” which is typically in the form of one of two types of structures that provide support to the solar panel element, namely a support frame or a panel rail. A solar panel “support frame” is typically in the form of a rigid material that surrounds the edges of the solar panel element, the combination of the element and the framing making the solar panel. A frameless solar panel does not have a peripheral support frame, but rather is typically supported from beneath by rigid structures, such as one or more support rails. The term “support rail” includes any rigid structure of any shape attached to the underside of a solar panel element that can be used for attachment to a panel mount in accordance with the present disclosure. Thus, a support frame describes a peripheral panel support and the term support rail describes an underside panel support.

As a note, terms like “first,” “second,” “third,” etc. used herein to differentiate structures relative to one another, do not infer order or arrangement. Sometimes, for example, a solar panel may be inserted into a panel mount including a “first” retaining feature, such as a retaining channel, a spring-loaded pin, a flexible panel mount, a lead-in latch, an over-center linkage assembly, etc., followed by a “second” retaining feature. It is understood that any of the retaining features could likewise have a “second” feature followed by a “first” retaining feature without consequence.

Similarly, in some instances, relative direction or orientation language is used herein, such as “upper,” “lower,” “downward,” etc. It is emphasized that these terms are relative and are based on the location of the torque tube, the torque tube clamp(s), and/or the panel mount, depending on the context. For example, if installing a solar panel in a horizontal or flat orientation into a pair of adjacently located panel mounts, then upper, lower, downward, etc., directions or orientations would coincide with those terms as typically used. However, if a solar panel is installed at an angle other than horizontal, a “downward” force would be in a direction toward the panel mount carried by the torque tube.

A “torque tube clamp” is defined as the structure that is attached to the torque tube of a solar panel array so that when the torque tube is rotated transversely, e.g., orthogonally, relative to the torque tube length, the torque tube clamp stays affixed and rotates the same angular degrees as the surface of the torque tube. In some examples, the torque tube clamp can be installed without the use of separate fasteners. For example, the torque tube clamp may include a “self-locking” feature requiring only one force to be applied at a location to cause the torque tube clamp to become immovably locked on the torque tube. The term “self-locking” does not infer that the mechanism locks itself automatically, but rather indicates that when the mechanism is modified from an open torque tube-accepting position to a closed position firmly about the torque tube, that the torque tube clamp can be locked due to the design of the torque tube clamp without the need of additional fasteners, e.g., the closing of the torque tube clamp about the torque tube provides the locking function. The installation of a solar panel along the torque tube typically utilizes two torque tube clamps, each attached to inward facing panel mounts.

The terms “aperture” is used herein in the context of panel support apertures, e.g., openings in solar panel frames and/or solar panel rails, panel mount apertures, e.g., openings in the panel mounts, and clamp support apertures, e.g., openings in the clamp support. However, it is noted that the term “aperture” herein refers to various types of openings, including openings that are punched through a material, openings that are detents that are not punched through a material, or the like. Thus, an aperture includes any recessed structure or hole through a structure that is functional for receiving a pin, latch, bump, or other process in accordance with the present disclosure.

It is to be understood that the examples of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular examples only and is not intended to be limiting.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various examples of the present invention can be referred to herein along with alternatives for the various components thereof. It is understood that such examples and alternatives are not to be construed as de facto equivalents of one another, but are to be considered as separate and autonomous representations of the present technology.

Furthermore, the described features, structures, or characteristics can be combined in any suitable manner in one or more examples. In the description, numerous specific details are provided, such as examples of lengths, widths, shapes, etc., to provide a thorough understanding of examples of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description. Reference throughout this specification to “one example” or “an example” means that a particular feature, structure, or characteristic described in connection with the example is included in at least one example of the present invention. Thus, appearances of the phrases “in one example” or “in an example” in various places throughout this specification are not necessarily all referring to the same example.

Although the disclosure may not expressly disclose that some examples or features described herein may be combined or interchanged with other examples or features described herein, this disclosure should be read to describe any such combinations that would be practicable by one of ordinary skill in the art no matter the specific examples that were described. Indeed, unless a certain combination of elements or functions not expressly disclosed would conflict with one another, such that the combination would render the resulting example inoperable or impracticable as would be apparent to those skilled in the art, this disclosure is meant to contemplate that any disclosed element or feature or function in any example described herein can be incorporated into any other example described herein (e.g., the elements or features or functions combined or interchanged with other elements or features or functions across examples) even though such combinations or interchange of elements or features or functions and resulting examples may not have been specifically or expressly disclosed and described. Indeed, the following examples are further illustrative of several embodiments of the present technology:

### EXAMPLE EMBODIMENTS

Example 1. A solar panel mounting system, comprising:

a first panel mount including a first retaining feature attached to or attachable to a first torque tube clamp; and

a second panel mount including a second retaining feature attached to or attachable to a second torque tube clamp;

wherein when the first and second panel mounts are mounted on a torque tube via the first and second torque tube clamps, respectively, the first retaining channel faces the second retaining channel, and the first and second retaining channels are oriented orthogonally relative to the torque tube, and

wherein at least one of the first panel mount or the second panel mount is configured for overhead or lateral insertion of a solar panel while the torque tube clamps are installed on the torque tube.

Example 2. The solar panel mounting system of example 1, wherein the first retaining feature, the second retaining feature, or both are in the form of a first retaining channel, a second retaining channel, or both.

Example 3. The solar panel mounting system of example 2, wherein further comprising a biasing structure within the first retaining channel, the second retaining channel, or both.

Example 4. The solar panel mounting system of example 2, wherein the first retaining channel is defined by three channel walls, wherein a lower channel wall is oriented orthogonally relative to a rear channel wall, and wherein an upper channel wall is angled at greater than about 95° relative to the rear channel wall, wherein the upper channel wall is configured to receive the solar panel from overhead at an angle of insertion greater than about 5° relative to the orientation of the first channel wall.

Example 5. The solar panel mounting system of example 2, wherein the first panel mount, the second panel mount, or both are pivotable or pivoted to an open orientation to provide clearance for overhead solar panel insertion into the first support channel, the second support channel, or both, and wherein upon insertion, the first panel mount, the second panel mount, or both are pivotable to a closed orientation upon application of a downward force.

Example 6. The solar panel mounting system of example 5, wherein the first panel mount, the second panel mount, or both are pivotable to the closed position upon application of the downward force applied to the solar panel during overhead insertion.

Example 7. The solar panel mounting system of any one of examples 1-6, wherein the first panel mount and the second panel mount are cantilevered orthogonally relative to the torque tube.

Example 8. The solar panel mounting system of any of examples 1-7, wherein the first retaining feature is a spring-loaded pin and the second retaining feature is a fixed pin that is shorter than the spring-loaded pin, and wherein the solar panel includes a support frame or support rails with corresponding panel support apertures positioned for overhead insertion of the solar panel to engage with the spring-loaded pin and the fixed pin.

Example 9. The solar panel mounting system of any of examples 1-8, wherein the first retaining feature, the second retaining feature, or both include a multi-level engagement pin for slidable insertion of the solar panel between the first panel mount and the second panel mount.

Example 10. The solar panel mounting system of example 9, wherein in operation, the multi-level engagement pin includes an initial mid-level elevation, followed by a recessed elevation that occurs during slidable insertion of the solar panel, followed by an extended elevation when a panel support aperture of a support frame or support rail of the solar panel becomes aligned with the multi-level engagement pin, thereby allowing the multi-level engagement pin to become seated in the panel support aperture at the extended elevation.

Example 11. The solar panel mounting system of any of examples 1-10, wherein the first retaining feature, the second retaining feature, or both include a pin coupled with a pin lever mechanism.

Example 12. The solar panel mounting system of example 11, wherein the pin and the pin lever mechanism are both present on a common rotatable levered pin

Example 13. The solar panel mounting system of example 11, wherein the pin is a spring-loaded pin.

Example 14. The solar panel mounting system of example 13, wherein when the lever mechanism is actuated by a solar panel during slidable insertion between the first panel mount and the second panel mount, and wherein the spring-loaded pin exhibits force against a support frame or a support rail of the solar panel until a panel support aperture of the support frame or support rail seats the spring-loaded pin in the aperture.

Example 15. The solar panel mounting system of any of examples 1-14, wherein the first and second retaining features include a spring-loaded pin, wherein the support frame or support rails of the solar panel include one or more angled retraction features to cause the spring-loaded pins to retract into the first retaining feature, the second retaining feature, or both upon overhead insertion of the solar panel, and wherein the support frame or support rails of the solar panel include a plurality of panel support apertures to permit the spring-loaded pin to release from being retracted to become seated in the panel support apertures.

Example 16. The solar panel mounting system of any of examples 1-15, wherein the first retaining feature, the second retaining feature, or both are flexible and configured to receive and retain a support frame or a support rail of a solar panel.

Example 17. The solar panel mounting system of example 16, wherein the first retaining feature, the second retaining feature, or both include a retaining button is positioned to retain the support frame above the solar panel.

Example 18. The solar panel mounting system of example 16, wherein the first retaining feature, the second retaining feature, or both include a retaining button positioned to retain the support frame at a panel support aperture along a side surface of the solar panel.

Example 19. The solar panel mounting system of example 16, wherein the first retaining feature, the second retaining feature, or both include a retaining button positioned to retain a support rail of a frameless solar panel.

Example 20. The solar panel mounting system of example 16, wherein the first retaining feature and the second retaining feature are offset laterally in a direction orthogonal with the torque tube when attached thereto via the torque tube clamp.

Example 21. The solar panel mounting system of example 16, wherein the first retaining feature, the second retaining feature, or both include a biasing structure and a flexure lock.

Example 22. The solar panel mounting system of any of examples 1-21, wherein the first retaining feature, the second retaining feature, or both include a lead-in latch assembly to receive and retain a support frame or a support rail of a solar panel.

Example 23. The solar panel mounting system of example 22, wherein the lead-in latch assembly includes at least one edge lead-in latch assembly.

Example 24. The solar panel mounting system of example 22, wherein the lead-in latch assembly includes at least one facial lead-in latch assembly.

Example 25. The solar panel mounting system of example 22, wherein the lead-in latch assembly includes both an edge lead-in latch assembly and a facial lead-in latch assembly configured for engaging one side of the support frame or the support rail of the solar panel.

Example 26. The solar panel mounting system of example 22, wherein the lead-in latch assembly includes multiple lead-in latch assemblies with different colors or optical markers, mechanical fiducials, or a combination thereof for interacting with an automated panel insertion device or vehicle.

Example 27. The solar panel mounting system of any of examples 1-26, wherein the first retaining feature, the second retaining feature, or both include an over-center linkage assembly to receive and retain a support frame or a support rail of a solar panel.

Example 28. The solar panel mounting system of example 27, wherein at least one of the bars in the over-center linkage assembly provides a recessed region suitable to provide a centering lead-in for an edge a solar panel being inserted.

Example 29. The solar panel mounting system of example 27, wherein the over-center linkage is part of at least a four bar linkage assembly.

Example 30. The solar panel mounting system of example 27, wherein the over-center linkage is part of at least a six bar linkage assembly that is at least partially engageable by insertion of a solar panel onto an extended lever arm associated with a ground bar.

Example 31. The solar panel mounting system of any of examples 1-30, wherein the first retaining feature, the second retaining feature, or both include a panel-side snap to receive and retain a support frame or a support rail of a solar panel.

Example 32. The solar panel mounting system of example 31, wherein the panel-side snap is configured for engagement with a panel mount aperture in the support frame or the support rail.

Example 33. The solar panel mounting system of example 32, wherein the panel-side snap is part of a double-sided snap, further comprising a clamp-side snap configured for engagement with a clamp support aperture of a clamp support.

Example 34. The solar panel mounting system of example 31, wherein the panel-side snap includes a plurality of flexible standoffs suitable for inward compression to pass through a panel mount aperture, each flexible standoff having a retaining button for retaining the support frame or the support rail.

Example 35. A method of installing solar panels, comprising:

coupling a plurality of torque tube clamps at multiple locations along an elongated torque tube;

individually coupling a plurality of panel mounts to the plurality of torque tube clamps, wherein the panel mounts are oriented orthogonal with respect to the torque tube, wherein the panel mounts each include a retaining feature configured to engage with a support frame or support rail of a solar panel; and

installing a plurality of solar panels to engage with retaining features of multiple panel mounts positioned adjacent one another in a direction along the torque tube without the need of separate hardware or fasteners other than retaining features integrated as part of the panel mounts.

Example 36. The method of example 35, wherein the plurality of panel mounts are individually coupled to the plurality of torque tube clamps prior to coupling the plurality of torque tube clamps to the elongated torque tube.

Example 37. The method of any one of examples 35-36, wherein the plurality of panel mounts are individually coupled to the plurality of torque tube clamps after coupling the plurality of torque tube clamps to the elongated torque tube.

Example 38. The method of any one of examples 35-37, wherein the plurality of panel mounts are coupled to the plurality of torque tube clamps during manufacturing as an inseparable monolithic structure.

Example 39. The method of any one of examples 35-38, wherein the retaining features are in the form of retaining channels.

Example 40. The method of example 39, wherein further comprising a biasing structure within the retaining channels.

Example 41. The method of example 39, wherein a first retaining channel one side of the solar panel is defined by three channel walls, wherein a lower channel wall is oriented orthogonally relative to a rear channel wall, and wherein an upper channel wall is angled at greater than about 95° relative to the rear channel wall, wherein the upper channel wall is configured to receive the solar panel from overhead at an angle of insertion greater than about 5° relative to the orientation of the first channel wall.

Example 42. The method of example 39, wherein one or both of the retaining channels are pivotable or pivoted to an open orientation to provide clearance for overhead solar panel insertion into one or both of the retaining channels and wherein upon insertion, one or both of the retaining channels are pivotable to a closed orientation upon application of a downward force.

Example 43. The method of example 42, wherein one or both of the retaining channels are pivotable to the closed position upon application of the downward force applied to the solar panel during overhead insertion.

Example 44. The method of any one of examples 35-43, wherein the panel mounts are cantilevered orthogonally relative to the torque tube.

Example 45. The method of any one of examples 35-44, wherein the multiple retaining features positioned adjacent one another include a first retaining feature and a second retaining feature on one side of the solar panel which includes a first pin and a biasing structure, respectively, and a third retaining feature the other side of the solar panel including a second shorter pin, and wherein the solar panel includes a support frame or support rails with corresponding panel support apertures for overhead insertion of the solar panel to align with their respective panel support apertures, and wherein the biasing structure provides a spring force from the first pin seated within its panel support aperture toward the second shorter pin.

Example 46. The method of any one of examples 35-45, wherein the multiple retaining features positioned adjacent one another include a multi-level engagement pin for slidable insertion of the solar panel between the first panel mount and the second panel mount.

Example 47. The method of example 46, wherein in operation, the multi-level engagement pin includes an initial mid-level elevation, followed by a recessed elevation that occurs during slidable insertion of the solar panel, followed by an extended elevation when a panel support aperture of a support frame or support rail of the solar panel becomes aligned with the multi-level engagement pin, thereby allowing the multi-level engagement pin to become seated in the panel support aperture at the extended elevation.

Example 48. The method of any one of examples 35-47, wherein the multiple retaining features positioned adjacent one another include a pin coupled with a pin lever mechanism.

Example 49. The method of example 48, wherein the pin and the pin lever mechanism are both present on a common rotatable levered pin.

Example 50. The method of example 48, wherein the pin is a spring-loaded pin.

Example 51. The method of example 50, wherein when the lever mechanism is actuated by a solar panel during slidable insertion between the retaining features positioned adjacent one another, the spring-loaded pin exhibits force against a support frame or a support rail of the solar panel until a panel support aperture of the support frame or support rail seats the spring-loaded pin in the aperture.

Example 52. The method of any one of examples 35-51, wherein the retaining features positioned adjacent one another include spring-loaded pins, wherein the support frame or support rails of the solar panel include one or more angled retraction features to cause the spring-loaded pins to retract into the retaining features positioned adjacent one another upon overhead insertion of the solar panel, and wherein the support frame or support rails of the solar panel include a plurality of panel support apertures to permit the spring-loaded pin to release from being retracted to become seated in the panel support apertures.

Example 53. The method of any one of examples 35-52, wherein multiple retaining features positioned adjacent one another are flexible and include a retaining button positioned to receive and retain a support frame or a support rail of a solar panel.

Example 54. The method of example 53, wherein retaining button is positioned to retain the support frame above the solar panel.

Example 55. The method of example 53, wherein retaining button is positioned to retain the support frame at a panel support aperture along a side surface of the solar panel.

Example 56. The method of example 53, wherein the retaining button is positioned to retain a support rail of a frameless solar panel.

Example 57. The method of example 53, wherein the multiple retaining features are offset laterally in a direction orthogonal with the torque tube when attached thereto via the torque tube clamp.

Example 58. The method of any one of examples 35-57, wherein installing the solar panels includes overhead installation of solar panels between the multiple panel mounts to engage with multiple retaining features thereof.

Example 59. The method of any one of examples 35-58, wherein installing the solar panels includes lateral slide installation of individual solar panels between the multiple panel mounts to engage with the multiple retaining features thereof.

Example 60. The method of any one of examples 35-59, wherein the multiple retaining features positioned adjacent one another include a biasing structure and a flexure lock.

Example 61. The method of any one of examples 35-60, wherein the multiple retaining features positioned adjacent one another include a lead-in latch assembly to receive and retain a support frame or a support rail of a solar panel.

Example 62. The method of any one of examples 35-61, wherein the multiple retaining features positioned adjacent one another include both an edge lead-in latch assembly and a facial lead-in latch assembly configured for engaging one side of the support frame or the support rail of the solar panel.

Example 63. The method of any one of examples 35-62, wherein the multiple retaining features positioned adjacent one another include an over-center linkage assembly to receive and retain a support frame or a support rail of a solar panel.

Example 64. The method of example 63, wherein the over-center linkage assembly is activated by at least partially engageable insertion of a solar panel and exerting a force on an extended lever arm associated with a ground bar.

Example 65. The method of any one of examples 35-64, wherein the multiple retaining features positioned adjacent one another include panel-side snaps to receive and retain support frames or a support rails of adjacently installed solar panels, wherein the panel-side snaps each include a plurality of flexible standoffs and a retaining button suitable for inward compression to pass through a panel support aperture.

Example 66. The method of example 65, wherein the panel-side snap is part of a double-sided snap, further comprising a clamp-side snap configured for engagement with a panel mount aperture or a clamp support aperture of a clamp support.

Example 67. The method of any one of examples 35-66, wherein installing the plurality of solar panels includes generating panel support apertures in the support frame or support rails using automation at the time of installation for engagement with retaining features of the panel mount configured to be received by the pane support apertures.

Example 68. A panel mount clamp assembly, comprising:

a torque tube clamp attachable to a torque tube, such that when the torque tube clamp is secured to the torque tube, the torque tube clamp rotates with the torque tube without slipping;

a panel mount attached to or integrated with the torque tube clamp, wherein the panel mount includes a first retaining feature adapted to receive and retain a first support frame or support rail of a first solar panel and a second retaining feature adapted to receive and retain a second support frame or support rail of a second solar panel installed adjacently relative to the first solar panel.

Example 69. The panel mount clamp assembly of example 68, wherein the first retaining feature, the second retaining feature, or both are in the form of a first retaining channel, a second retaining channel, or both.

Example 70. The panel mount clamp assembly of example 69, wherein further comprising a biasing structure within the first retaining channel, the second retaining channel, or both.

Example 71. The panel mount clamp assembly of example 69, wherein the first retaining channel is defined by three channel walls, wherein a lower channel wall is oriented orthogonally relative to a rear channel wall, and wherein an upper channel wall is angled at greater than about 95° relative to the rear channel wall, wherein the upper channel wall is configured to receive the solar panel from overhead at an angle of insertion greater than about 5° relative to the orientation of the first channel wall.

Example 72. The panel mount clamp assembly of example 69, wherein the first panel mount, the second panel mount, or both are pivotable or pivoted to an open orientation to provide clearance for overhead solar panel insertion into the first support channel, the second support channel, or both, and wherein upon insertion, the first panel mount, the second panel mount, or both are pivotable to a closed orientation upon application of a downward force.

Example 73. The panel mount clamp assembly of example 72, wherein the first panel mount or the second panel mount or both are pivotable to the closed position upon application of the downward force applied to the first solar panel or the second solar panel, respectively, during overhead insertion.

Example 74. The panel mount clamp assembly of any one of examples 68-, wherein the first retaining feature includes a first pin and a biasing structure, and the second retaining feature includes a second shorter pin, wherein the first pin and the biasing structure provide for installation of a solar panel with a panel support aperture and to provide a spring force away from the retaining feature to a second shorter pin of an adjacently installed panel mount clamp assembly.

Example 75. The panel mount clamp assembly of any one of examples 68-74, wherein the first retaining feature, the second retaining feature, or both include a multi-level engagement pin for slidable insertion of the first solar panel, the second solar panel, or both.

Example 76. The panel mount clamp assembly of any one of examples 68-75, wherein in operation, the multi-level engagement pin includes an initial mid-level elevation, followed by a recessed elevation that occurs during slidable insertion of the solar panel, followed by an extended elevation when a panel support aperture of a support frame or support rail of the first or second solar panel becomes aligned with the multi-level engagement pin, thereby allowing the multi-level engagement pin to become seated in the panel support aperture at the extended elevation.

Example 77. The panel mount clamp assembly of any one of examples 68-76, wherein the first retaining feature, the second retaining feature, or both include a pin coupled with a pin lever mechanism.

Example 78. The panel mount clamp assembly of example 77, wherein the pin and the pin lever mechanism are both present on a common rotatable levered pin.

Example 79. The panel mount clamp assembly of example 77, wherein the pin is a spring-loaded pin.

Example 80. The panel mount clamp assembly of example 79, wherein when the lever mechanism is actuated by a solar panel during slidable insertion along the panel mount, and wherein the spring-loaded pin exhibits force against a support frame or a support rail of the solar panel until a panel support aperture of the support frame or support rail seats the spring-loaded pin in the aperture.

Example 81. The panel mount clamp assembly of any one of examples 68-80, wherein the first and second retaining features include spring-loaded pins, wherein the first support frame or support rail includes an angled retraction feature to cause a plurality of the spring-loaded pins to retract during insertion of the first solar panel, wherein the second support frame or support rail includes also includes an angle retraction features to cause a plurality of the spring-loaded pins to retract during insertion of the solar panel, and wherein the first and second support frame or support rail include a plurality of panel support apertures to permit the spring-loaded pins to release from being retracted to become seated in corresponding panel support apertures.

Example 82. The panel mount clamp assembly of any one of examples 68-81, wherein the first retaining feature, the second retaining feature, or both are each in the form of a flexible retaining feature with a retaining button positioned to receive and retain the first and second support frame or support rail, respectively.

Example 83. The panel mount clamp assembly of example 82, wherein the retaining buttons of the first and second retaining features are positioned to retain the first and second solar panels above the first and second support frames, respectively.

Example 84. The panel mount clamp assembly of example 82, wherein the retaining buttons of the first and second retaining features are positioned to retain the first and second solar panels at a panel support aperture along a side surface of the first and second support frame or support rail, respectively.

Example 85. The panel mount clamp assembly of example 82, wherein the retaining buttons of the first and second retaining features are positioned to retain the first and second solar panels at the first and second support rail of frameless solar panels.

Example 86. The panel mount clamp assembly of example 82, wherein the first retaining feature, the second retaining feature, or both include a pin coupled with a pin lever mechanism.

Example 87. The panel mount clamp assembly of any one of examples 68-86, wherein the first retaining feature, the second retaining feature, or both include a panel-side snap to receive and retain a support frame or a support rail of a solar panel.

Example 88. The panel mount clamp assembly of example 87, wherein the panel-side snap is configured for engagement with a panel mount aperture in the support frame or the support rail.

Example 89. The panel mount clamp assembly of example 88, wherein the panel-side snap is part of a double-sided snap, further comprising a clamp-side snap configured for engagement with a clamp support aperture of a clamp support.

Example 90. The panel mount clamp assembly of example 87, wherein the panel-side snap includes a plurality of flexible standoffs suitable for inward compression to pass through a panel mount aperture, each flexible standoff having a retaining button for retaining the support frame or the support rail.

Example 91. A method of installing a solar panel, comprising inserting a first solar panel and a second solar panel into any of the panel mount clamp assemblies of examples 68 to 90 to secure the first solar panel with the first retaining feature and to secure the second solar panel with the second retaining feature.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

The term “comprising” is used throughout to mean including at least the recited feature(s) such that any greater number of the same feature and/or additional types of other features are not precluded. It will also be appreciated that specific embodiments have been described herein for purposes of illustration, but that various modifications can be made without deviating from the technology. Further, while advantages associated with some embodiments of the present technology have been described in the context of those embodiments, other embodiments can also exhibit such advantages, and not all embodiments need necessarily exhibit such advantages to fall within the scope of the technology. Accordingly, the disclosure and associated present technology can encompass other embodiments not expressly shown or described herein.

Moreover, unless the word “or” is expressly limited to mean only a single item exclusive from other items in reference to a list of two or more items, then the use of “or” in such a list is to be interpreted as including (a) any single item in the list, (b) all of the items in the list, or (c) any combination of the items in the list. In other words, the use of “or” in this disclosure should be understood to mean non-exclusive “or” (i.e., “and/or”) unless otherwise indicated herein.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described present technology.

What is claimed is:

1. A solar panel mounting system, comprising:
a first panel mount including a first retaining feature attached to or attachable to a first torque tube clamp; and
a second panel mount including a second retaining feature attached to or attachable to a second torque tube clamp;
wherein when the first and second panel mounts are mounted on a torque tube via the first and second torque tube clamps, respectively, the first retaining channel faces the second retaining channel, and the first and second retaining channels are oriented transversely relative to the torque tube, and
wherein at least one of the first panel mount or the second panel mount is configured for overhead or lateral insertion of a solar panel while the torque tube clamps are installed on the torque tube.

2. The solar panel mounting system of claim 1, wherein the first retaining feature, the second retaining feature, or both are in the form of a first retaining channel, a second retaining channel, or both.

3. The solar panel mounting system of claim 2, wherein further comprising a biasing structure within the first retaining channel, the second retaining channel, or both.

4. The solar panel mounting system of claim 2, wherein the first retaining channel is defined by three channel walls, wherein a lower channel wall is oriented orthogonally relative to a rear channel wall, and wherein an upper channel wall is angled at greater than about 95° relative to the rear channel wall, wherein the upper channel wall is configured to receive the solar panel from overhead at an angle of insertion greater than about 5° relative to the orientation of the first channel wall.

5. The solar panel mounting system of claim 2, wherein the first panel mount, the second panel mount, or both are pivotable or pivoted to an open orientation to provide clearance for overhead solar panel insertion into the first support channel, the second support channel, or both, and wherein upon insertion, the first panel mount, the second panel mount, or both are pivotable to a closed orientation upon application of a downward force.

6. The solar panel mounting system of claim 5, wherein the first panel mount, the second panel mount, or both are pivotable to the closed position upon application of the downward force applied to the solar panel during overhead insertion.

7. The solar panel mounting system of claim 1, wherein the first panel mount and the second panel mount are cantilevered orthogonally relative to the torque tube.

8. The solar panel mounting system of claim 1, wherein the first retaining feature includes a first pin and a biasing structure, and the second retaining feature includes a second shorter pin, wherein the first pin and the biasing structure provide for installation of a solar panel with a panel support aperture and to provide a spring force away from the retaining feature to a second shorter pin of an adjacently installed panel mount clamp assembly.

9. The solar panel mounting system of claim 1, wherein the first retaining feature, the second retaining feature, or both include a multi-level engagement pin for slidable insertion of the solar panel between the first panel mount and the second panel mount.

10. The solar panel mounting system of claim 9, wherein in operation, the multi-level engagement pin includes an initial mid-level elevation, followed by a recessed elevation that occurs during slidable insertion of the solar panel, followed by an extended elevation when a panel support aperture of a support frame or support rail of the solar panel becomes aligned with the multi-level engagement pin, thereby allowing the multi-level engagement pin to become seated in the panel support aperture at the extended elevation.

11. The solar panel mounting system of claim 1, wherein the first retaining feature, the second retaining feature, or both include a pin coupled with a pin lever mechanism.

12. The solar panel mounting system of claim 11, wherein the pin and the pin lever mechanism are both present on a common rotatable levered pin.

13. The solar panel mounting system of claim 11, wherein the pin is a spring-loaded pin.

14. The solar panel mounting system of claim 13, wherein when the lever mechanism is actuated by a solar panel during slidable insertion between the first panel mount and the second panel mount, and wherein the spring-loaded pin exhibits force against a support frame or a support rail of the solar panel until a panel support aperture of the support frame or support rail seats the spring-loaded pin in the aperture.

15. The solar panel mounting system of claim 1, wherein the first and second retaining features include a spring-loaded pin, wherein the support frame or support rails of the solar panel include one or more angled retraction features to cause the spring-loaded pins to retract into the first retaining feature, the second retaining feature, or both upon overhead insertion of the solar panel, and wherein the support frame or support rails of the solar panel include a plurality of panel support apertures to permit the spring-loaded pin to release from being retracted to become seated in the panel support apertures.

16. The solar panel mounting system of claim 1, wherein the first retaining feature, the second retaining feature, or both are flexible and configured to receive and retain a support frame or a support rail of a solar panel.

17. The solar panel mounting system of claim 16, wherein the first retaining feature, the second retaining feature, or both include a retaining button is positioned to retain the support frame above the solar panel.

18. The solar panel mounting system of claim 16, wherein the first retaining feature, the second retaining feature, or both include a retaining button positioned to retain the support frame at a panel support aperture along a side surface of the solar panel.

19. The solar panel mounting system of claim 16, wherein the first retaining feature, the second retaining feature, or both include a retaining button positioned to retain a support rail of a frameless solar panel.

20. The solar panel mounting system of claim 16, wherein the first retaining feature and the second retaining feature are offset laterally in a direction orthogonal with the torque tube when attached thereto via the torque tube clamp.

21. The solar panel mounting system of claim 16, wherein the first retaining feature, the second retaining feature, or both include a biasing structure and a flexure lock.

22. The solar panel mounting system of claim 1, wherein the first retaining feature, the second retaining feature, or both include a lead-in latch assembly to receive and retain a support frame or a support rail of a solar panel.

23. The solar panel mounting system of claim 22, wherein the lead-in latch assembly includes at least one edge lead-in latch assembly.

24. The solar panel mounting system of claim 22, wherein the lead-in latch assembly includes at least one facial lead-in latch assembly.

25. The solar panel mounting system of claim 22, wherein the lead-in latch assembly includes both an edge lead-in latch assembly and a facial lead-in latch assembly configured for engaging one side of the support frame or the support rail of the solar panel.

26. The solar panel mounting system of claim 22, wherein the lead-in latch assembly includes multiple lead-in latch assemblies with different colors or optical markers, mechanical fiducials, or a combination thereof for interacting with an automated panel insertion device or vehicle.

27. The solar panel mounting system of claim 1, wherein the first retaining feature, the second retaining feature, or both include an over-center linkage assembly to receive and retain a support frame or a support rail of a solar panel.

28. The solar panel mounting system of claim 27, wherein at least one of the bars in the over-center linkage assembly provides a recessed region suitable to provide a centering lead-in for an edge a solar panel being inserted.

29. The solar panel mounting system of claim 27, wherein the over-center linkage is part of at least a four-bar linkage assembly.

30. The solar panel mounting system of claim 27, wherein the over-center linkage is part of at least a six-bar linkage assembly that is at least partially engageable by insertion of a solar panel onto an extended lever arm associated with a ground bar.

31. The solar panel mounting system of claim 1, wherein the first retaining feature, the second retaining feature, or both include a panel-side snap to receive and retain a support frame or a support rail of a solar panel.

32. The solar panel mounting system of claim 31, wherein the panel-side snap is configured for engagement with a panel mount aperture in the support frame or the support rail.

33. The solar panel mounting system of claim 32, wherein the panel-side snap is part of a double-sided snap, further comprising a clamp-side snap configured for engagement with a clamp support aperture of a clamp support.

34. The solar panel mounting system of claim 31, wherein the panel-side snap includes a plurality of flexible standoffs suitable for inward compression to pass through a panel mount aperture, each flexible standoff having a retaining button for retaining the support frame or the support rail.

35. A method of installing solar panels, comprising:
coupling a plurality of torque tube clamps at multiple locations along an elongated torque tube;
individually coupling a plurality of panel mounts to the plurality of torque tube clamps, wherein the panel mounts are oriented transversely with respect to the torque tube, wherein the panel mounts each include a retaining feature configured to engage with a support frame or support rail of a solar panel; and
installing a plurality of solar panels to engage with retaining features of multiple panel mounts positioned adjacent one another in a direction along the torque tube without the need of separate hardware or fasteners other than retaining features integrated as part of the panel mounts.

36. The method of claim 35, wherein the plurality of panel mounts are individually coupled to the plurality of torque tube clamps prior to coupling the plurality of torque tube clamps to the elongated torque tube.

37. The method of claim 35, wherein the plurality of panel mounts are individually coupled to the plurality of torque tube clamps after coupling the plurality of torque tube clamps to the elongated torque tube.

38. The method of claim 35, wherein the plurality of panel mounts are coupled to the plurality of torque tube clamps during manufacturing as an inseparable monolithic structure.

39. The method of claim 35, wherein the retaining features are in the form of retaining channels.

40. The method of claim 39, wherein further comprising a biasing structure within the retaining channels.

41. The method of claim 39, wherein a first retaining channel one side of the solar panel is defined by three channel walls, wherein a lower channel wall is oriented orthogonally relative to a rear channel wall, and wherein an upper channel wall is angled at greater than about 95° relative to the rear channel wall, wherein the upper channel wall is configured to receive the solar panel from overhead at an angle of insertion greater than about 5° relative to the orientation of the first channel wall.

42. The method of claim 39, wherein one or both of the retaining channels are pivotable or pivoted to an open orientation to provide clearance for overhead solar panel insertion into one or both of the retaining channels and wherein upon insertion, one or both of the retaining channels are pivotable to a closed orientation upon application of a downward force.

43. The method of claim 42, wherein one or both of the retaining channels are pivotable to the closed position upon application of the downward force applied to the solar panel during overhead insertion.

44. The method of claim 35, wherein the panel mounts are cantilevered orthogonally relative to the torque tube.

45. The method of claim 35, wherein the multiple retaining features positioned adjacent one another include a first retaining feature and a second retaining feature on one side of the solar panel which includes a first pin and a biasing structure, respectively, and a third retaining feature the other side of the solar panel including a second shorter pin, and wherein the solar panel includes a support frame or support rails with corresponding panel support apertures for overhead insertion of the solar panel to align with their respective panel support apertures, and wherein the biasing structure provides a spring force from the first pin seated within its panel support aperture toward the second shorter pin.

46. The method of claim 35, wherein the multiple retaining features positioned adjacent one another include a multi-level engagement pin for slidable insertion of the solar panel between the first panel mount and the second panel mount.

47. The method of claim 46, wherein in operation, the multi-level engagement pin includes an initial mid-level elevation, followed by a recessed elevation that occurs during slidable insertion of the solar panel, followed by an extended elevation when a panel support aperture of a support frame or support rail of the solar panel becomes aligned with the multi-level engagement pin, thereby allowing the multi-level engagement pin to become seated in the panel support aperture at the extended elevation.

48. The method of claim 35, wherein the multiple retaining features positioned adjacent one another include a pin coupled with a pin lever mechanism.

49. The method of claim 48, wherein the pin and the pin lever mechanism are both present on a common rotatable levered pin.

50. The method of claim 48, wherein the pin is a spring-loaded pin.

51. The method of claim 50, wherein when the lever mechanism is actuated by a solar panel during slidable insertion between the retaining features positioned adjacent one another, the spring-loaded pin exhibits force against a support frame or a support rail of the solar panel until a panel support aperture of the support frame or support rail seats the spring-loaded pin in the aperture.

52. The method of claim 35, wherein the retaining features positioned adjacent one another include spring-loaded pins, wherein the support frame or support rails of the solar panel include one or more angled retraction features to cause the spring-loaded pins to retract into the retaining features positioned adjacent one another upon overhead insertion of the solar panel, and wherein the support frame or support rails of the solar panel include a plurality of panel support apertures to permit the spring-loaded pin to release from being retracted to become seated in the panel support apertures.

53. The method of claim 35, wherein multiple retaining features positioned adjacent one another are flexible and include a retaining button positioned to receive and retain a support frame or a support rail of a solar panel.

54. The method of claim 53, wherein retaining button is positioned to retain the support frame above the solar panel.

55. The method of claim 53, wherein retaining button is positioned to retain the support frame at a panel support aperture along a side surface of the solar panel.

56. The method of claim 53, wherein the retaining button is positioned to retain a support rail of a frameless solar panel.

57. The method of claim 53, wherein the multiple retaining features are offset laterally in a direction orthogonal with the torque tube when attached thereto via the torque tube clamp.

58. The method of claim 35, wherein installing the solar panels includes overhead installation of solar panels between the multiple panel mounts to engage with multiple retaining features thereof.

59. The method of claim 35, wherein installing the solar panels includes lateral slide installation of individual solar panels between the multiple panel mounts to engage with the multiple retaining features thereof.

60. The method of claim 35, wherein the multiple retaining features positioned adjacent one another include a biasing structure and a flexure lock.

61. The method of claim 35, wherein the multiple retaining features positioned adjacent one another include a lead-in latch assembly to receive and retain a support frame or a support rail of a solar panel.

62. The method of claim 35, wherein the multiple retaining features positioned adjacent one another include both an edge lead-in latch assembly and a facial lead-in latch assembly configured for engaging one side of the support frame or the support rail of the solar panel.

63. The method of claim 35, wherein the multiple retaining features positioned adjacent one another include an over-center linkage assembly to receive and retain a support frame or a support rail of a solar panel.

64. The method of claim 63, wherein the over-center linkage assembly is activated by at least partially engageable insertion of a solar panel and exerting a force on an extended lever arm associated with a ground bar.

65. The method of claim 35, wherein the multiple retaining features positioned adjacent one another include panel-side snaps to receive and retain support frames or a support rails of adjacently installed solar panels, wherein the panel-side snaps each include a plurality of flexible standoffs and a retaining button suitable for inward compression to pass through a panel support aperture.

66. The method of claim 65, wherein the panel-side snap is part of a double-sided snap, further comprising a clamp-side snap configured for engagement with a panel mount aperture or a clamp support aperture of a clamp support.

67. The method of claim 35, wherein installing the plurality of solar panels includes generating panel support apertures in the support frame or support rails using automation at the time of installation for engagement with retaining features of the panel mount configured to be received by the panel support apertures.

68. A panel mount clamp assembly, comprising:
a torque tube clamp attachable to a torque tube, such that when the torque tube clamp is secured to the torque tube, the torque tube clamp rotates with the torque tube without slipping;
a panel mount attached to or integrated with the torque tube clamp, wherein the panel mount includes a first retaining feature adapted to receive and retain a first support frame or support rail of a first solar panel and a second retaining feature adapted to receive and retain a second support frame or support rail of a second solar panel installed adjacently relative to the first solar panel.

69. The panel mount clamp assembly of claim 68, wherein the first retaining feature, the second retaining feature, or both are in the form of a first retaining channel, a second retaining channel, or both.

70. The panel mount clamp assembly of claim 69, wherein further comprising a biasing structure within the first retaining channel, the second retaining channel, or both.

71. The panel mount clamp assembly of claim 69, wherein the first retaining channel is defined by three channel walls, wherein a lower channel wall is oriented orthogonally relative to a rear channel wall, and wherein an upper channel wall is angled at greater than about 95° relative to the rear channel wall, wherein the upper channel wall is configured to receive the solar panel from overhead at an angle of insertion greater than about 5° relative to the orientation of the first channel wall.

72. The panel mount clamp assembly of claim 69, wherein the first panel mount, the second panel mount, or both are pivotable or pivoted to an open orientation to provide clearance for overhead solar panel insertion into the first support channel, the second support channel, or both, and wherein upon insertion, the first panel mount, the second panel mount, or both are pivotable to a closed orientation upon application of a downward force.

73. The panel mount clamp assembly of claim 72, wherein the first panel mount or the second panel mount or both are pivotable to the closed position upon application of the downward force applied to the first solar panel or the second solar panel, respectively, during overhead insertion.

74. The panel mount clamp assembly of claim 68, wherein the first retaining feature includes a first pin and a biasing structure, and the second retaining feature includes a second shorter pin, wherein the first pin and the biasing structure provide for installation of a solar panel with a panel support aperture and to provide a spring force away from the retaining feature to a second shorter pin of an adjacently installed panel mount clamp assembly.

75. The panel mount clamp assembly of claim 68, wherein the first retaining feature, the second retaining feature, or both include a multi-level engagement pin for slidable insertion of the first solar panel, the second solar panel, or both.

76. The panel mount clamp assembly of claim 68, wherein in operation, the multi-level engagement pin includes an initial mid-level elevation, followed by a recessed elevation that occurs during slidable insertion of the solar panel, followed by an extended elevation when a panel support aperture of a support frame or support rail of the first or second solar panel becomes aligned with the multi-level engagement pin, thereby allowing the multi-level engagement pin to become seated in the panel support aperture at the extended elevation.

77. The panel mount clamp assembly of claim 68, wherein the first retaining feature, the second retaining feature, or both include a pin coupled with a pin lever mechanism.

78. The panel mount clamp assembly of claim 77, wherein the pin and the pin lever mechanism are both present on a common rotatable levered pin.

79. The panel mount clamp assembly of claim 77, wherein the pin is a spring-loaded pin.

80. The panel mount clamp assembly of claim 79, wherein when the lever mechanism is actuated by a solar panel during slidable insertion along the panel mount, and wherein the spring-loaded pin exhibits force against a support frame or a support rail of the solar panel until a panel support aperture of the support frame or support rail seats the spring-loaded pin in the aperture.

81. The panel mount clamp assembly of claim 68, wherein the first and second retaining features include spring-loaded pins, wherein the first support frame or support rail includes an angled retraction feature to cause a plurality of the spring-loaded pins to retract during insertion of the first solar panel, wherein the second support frame or support rail includes also includes an angle retraction features to cause a plurality of the spring-loaded pins to retract during insertion of the solar panel, and wherein the first and second support frame or support rail include a plurality of panel support apertures to permit the spring-loaded pins to release from being retracted to become seated in corresponding panel support apertures.

82. The panel mount clamp assembly of claim 68, wherein the first retaining feature, the second retaining feature, or both are each in the form of a flexible retaining feature with a retaining button positioned to receive and retain the first and second support frame or support rail, respectively.

83. The panel mount clamp assembly of claim 82, wherein the retaining buttons of the first and second retaining features are positioned to retain the first and second solar panels above the first and second support frames, respectively.

84. The panel mount clamp assembly of claim 82, wherein the retaining buttons of the first and second retaining features are positioned to retain the first and second solar panels at a panel support aperture along a side surface of the first and second support frame or support rail, respectively.

85. The panel mount clamp assembly of claim 82, wherein the retaining buttons of the first and second retaining features are positioned to retain the first and second solar panels at the first and second support rail of frameless solar panels.

86. The panel mount clamp assembly of claim 82, wherein the first retaining feature, the second retaining feature, or both include a pin coupled with a pin lever mechanism.

87. The panel mount clamp assembly of claim 68, wherein the first retaining feature, the second retaining feature, or both include a panel-side snap to receive and retain a support frame or a support rail of a solar panel.

88. The panel mount clamp assembly of claim 87, wherein the panel-side snap is configured for engagement with a panel mount aperture in the support frame or the support rail.

89. The panel mount clamp assembly of claim 88, wherein the panel-side snap is part of a double-sided snap, further comprising a clamp-side snap configured for engagement with a clamp support aperture of a clamp support.

90. The panel mount clamp assembly of claim 87, wherein the panel-side snap includes a plurality of flexible standoffs suitable for inward compression to pass through a panel mount aperture, each flexible standoff having a retaining button for retaining the support frame or the support rail.

91. A method of installing a solar panel, comprising inserting a first solar panel and a second solar panel into a panel mount clamp assembly to secure the first solar panel with the first retaining feature and to secure the second solar panel with the second retaining feature, the panel mount clamp assembly comprising:
a torque tube clamp attachable to a torque tube, such that when the torque tube clamp is secured to the torque tube, the torque tube clamp rotates with the torque tube without slipping;
a panel mount attached to or integrated with the torque tube clamp, wherein the panel mount includes a first retaining feature adapted to receive and retain a first support frame or support rail of a first solar panel and a second retaining feature adapted to receive and retain a second support frame or support rail of a second solar panel installed adjacently relative to the first solar panel.
